(19) United States
(12) Patent Application Publication
(10) Pub. No.: US 2014/0298207 A1
(43) Pub. Date: Oct. 2, 2014

(54) Systems and Methods for Managing Documents and Other Electronic Content

(71) Applicant: Intertrust Technologies Corporation, Sunnyvale, CA (US)

(72) Inventors: Gadi ITTAH, Cupertino, CA (US); David P. MAHER, Livermore, CA (US); Daniel VICKERY, San Francisco, CA (US); Peter JONES, San Francisco, CA (US); Sung CHUN, Millbrae, CA (US); Tauseef BASHIR, San Francisco, CA (US)

(21) Appl. No.: 14/229,650

(22) Filed: Mar. 28, 2014

Related U.S. Application Data
(60) Provisional application No. 61/806,590, filed on Mar. 29, 2013.

(51) Int. Cl. G06F 3/0482

(52) U.S. Cl. CPC G06F 3/0482
USPC 715/753

(57) ABSTRACT

This disclosure relates to systems and methods for enabling collaboration and/or task management between one or more users. Certain embodiments facilitate task management in connection with secure, governed, and/or audited collaboration and/or document management services using an interface that includes social communication features. Further embodiments relate to search operations returning active and/or functional search results that a user may interact with in connection with performing various activities in connection with a collaboration and/or document management service.

### RELATED APPLICATIONS

This application claims the benefit of priority under 35 U.S.C. §119(e) to U.S. Provisional Patent Application No. 61/806,590, filed Mar. 29, 2013, and entitled “SYSTEMS AND METHODS FOR MANAGING DOCUMENTS AND OTHER ELECTRONIC CONTENT”, which is hereby incorporated by reference in its entirety.

### COPYRIGHT AUTHORIZATION

Portions of the disclosure of this patent document may contain material which is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### BACKGROUND AND SUMMARY

The present disclosure relates generally to systems and methods for managing documents and other electronic works. More specifically, but not exclusively, the present disclosure relates to systems and methods for enabling secure, governed, and/or audited collaboration and/or document management over cloud storage platforms.

Cloud storage services such as Google Drive®, Microsoft SkyDrive®, DropBox® and iCloud® can provide users and enterprises with high availability remote document storage services. Among other benefits, cloud storage services may relieve users and enterprises from the need to manually transfer files between machines via mechanisms such as e-mail or USB drives, while providing valuable data management services including document backup. In addition, cloud storage services may help facilitate document distribution and collaboration between users within an enterprise.

From a risk management perspective, however, cloud storage services introduce certain potential liabilities for an organization. For example, much of an enterprise's sensitive information is captured in electronic documents that, via a cloud storage service, may be stored and managed by a third-party service provider outside of the enterprise's network boundaries. A malicious attack on a cloud storage service and/or unauthorized access or distribution of information stored on a cloud storage service may compromise an organization's sensitive information and be extremely damaging. Although such risks may be ameliorated through compliance with industry standards and certification and/or by auditing by third-party service providers, such activities may not be sufficient to ensure the security and integrity of information stored by a cloud storage service. Accordingly, systems and methods that facilitate an overall security and trust architecture with a cloud storage service are desirable.

Embodiments of the systems and methods disclosed herein can be used to enable secure, governed, and/or audited collaboration and/or document management over cloud storage platforms (e.g., third-party cloud storage platforms). In some embodiments, systems and methods are described for providing key and rights management as well as collaboration services in conjunction with cloud storage services (e.g., third-party services), thereby reducing the risk associated with storing enterprise content with such services.

Systems and methods disclosed herein may further facilitate task management in connection with secure, governed, and/or audited collaboration services using an integrated interface. Further embodiments provide for interaction with and/or use of such services in connection with mobile devices and/or integrated desktop interfaces. Certain systems and methods disclosed herein may provide for search functionality configured to return active search results that a user may interact with in connection with performing various activities disclosed herein. In yet further embodiments, the disclosed systems and methods may enable centralized administration of workspaces, collaborations, users, and/or other aspects of a collaboration and/or document management service through an administrator console interface.

### BRIEF DESCRIPTION OF THE DRAWINGS

The inventive body of work will be readily understood by referring to the following detailed description in conjunction with the accompanying drawings, in which:

FIG. 1 illustrates an exemplary ecosystem including a trusted service consistent with embodiments of the present disclosure.

FIG. 2 illustrates an exemplary architecture of a client system and a trusted service consistent with embodiments of the present disclosure.

FIG. 3 illustrates an exemplary interface for interacting with a collaboration system consistent with embodiments of the present disclosure.

FIG. 4 illustrates a top menu of an exemplary interface for interacting with a collaboration system consistent with embodiments of the present disclosure.

FIG. 5 illustrates a workspace navigator of an exemplary interface for interacting with a collaboration system consistent with embodiments of the present disclosure.

FIG. 6 illustrates a workspace menu of an exemplary interface for interacting with a collaboration system consistent with embodiments of the present disclosure.

FIG. 7 illustrates a workspace settings menu of an exemplary interface for interacting with a collaboration system consistent with embodiments of the present disclosure.

FIG. 8 illustrates a document navigation menu of an exemplary interface for interacting with a collaboration system consistent with embodiments of the present disclosure.

FIG. 9 illustrates a document usage menu of an exemplary interface for interacting with a collaboration system consistent with embodiments of the present disclosure.

FIG. 10 illustrates another document usage menu of an exemplary interface for interacting with a collaboration system consistent with embodiments of the present disclosure.

FIG. 11 illustrates an exemplary activity stream of an exemplary interface for interacting with a collaboration system consistent with embodiments of the present disclosure.

FIG. 12 illustrates a flow chart of an exemplary method of accessing a document stored by a cloud storage system consistent with embodiments of the present disclosure.

FIG. 13 illustrates a flow chart of an exemplary method of generating a document activity graph consistent with embodiments of the present disclosure.

FIG. 14 illustrates an exemplary interface for interacting with task management functionality of a collaboration system consistent with embodiments of the present disclosure.

FIG. 15 illustrates task management in connection with an activity stream of an exemplary interface for interacting with a collaboration system consistent with embodiments of the present disclosure.

FIG. 16 illustrates an exemplary task navigation menu of an exemplary interface for interacting with a collaboration system consistent with embodiments of the present disclosure.

FIG. 17 illustrates an exemplary task panel of an exemplary interface for interacting with a collaboration system consistent with embodiments of the present disclosure.

FIG. 18 illustrates an exemplary task creation menu of an exemplary interface for interacting with a collaboration system consistent with embodiments of the present disclosure.

FIG. 19 illustrates an exemplary mobile interface for interacting with a collaboration system consistent with embodiments of the present disclosure.

FIG. 20 illustrates an exemplary integrated desktop interface for interacting with a collaboration system consistent with embodiments of the present disclosure.

FIG. 21 illustrates an exemplary search panel for interacting with a collaboration system consistent with embodiments of the present disclosure.

FIG. 22 illustrates an exemplary administrator console for interacting with a collaboration system consistent with embodiments of the present disclosure

FIG. 23 illustrates an exemplary system that may be used to implement embodiments of the systems and methods of the present disclosure.

### DETAILED DESCRIPTION

A detailed description of systems and methods consistent with embodiments of the present disclosure is provided below. While several embodiments are described, it should be understood that the disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

The embodiments of the disclosure may be understood by reference to the drawings, wherein like parts may be designated by like numerals. The components of the disclosed embodiments, as generally described and illustrated in the figures herein, could be arranged and designed in a wide variety of different configurations. Thus, the following detailed description of the embodiments of the systems and methods of the disclosure is not intended to limit the scope of the disclosure, as claimed, but is merely representative of possible embodiments of the disclosure. In addition, the steps of any method disclosed herein do not necessarily need to be executed in any specific order, or even sequentially, nor need the steps be executed only once, unless otherwise specified.

Systems and methods are disclosed that facilitate secure, governed, and/or audited collaboration and/or document management over cloud storage and/or other platforms (e.g., third-party cloud storage platforms). In some embodiments, systems and methods are described for providing key and rights management as well as collaboration services in conjunction with cloud storage services, thereby reducing the risk associated with storing enterprise content with such remote services. It will be appreciated that these systems and methods are novel, as are many of the components, systems, and methods employed therein.

Systems and methods disclosed herein may further facilitate task management in connection with secure, governed, and/or audited collaboration services. In certain embodiments, task management functionality may be integrated with social collaboration and/or communication services in connection with a single interface. Integration of social communication and task management into a single feed or interface may facilitate more efficient project organization and coordination when compared to conventional systems in which social communication and task management are handled by separate products and/or in separate silos.

Further embodiments disclosed herein provide for secure, governed, and/or audited collaboration services in connection with mobile devices. In certain embodiments, an interface for interacting with a collaboration system using a mobile device may be optimized for the mobile device (e.g., a smartphone). In some embodiments, an application executing on the mobile device providing collaboration and/or document management services consistent with embodiments disclosed herein may be “locked” on the mobile device in a manner that prevents a user of the device from using other device features and/or applications. Such techniques may allow for deployment of customized enterprise-based mobiles devices implementing embodiments of the systems and methods disclosed herein with relative ease and lower cost. Further embodiments may provide for desktop integration of a secure, governed and/or audited collaboration and/or document management service.

In some embodiments, the disclosed systems and methods may provide for search functionality within an audited collaboration and/or document management service that returns active search results. A user may interact with various active search results in a variety of ways in connection with a search result interface. For example, if results of search query performed using an audited collaboration and/or document management service include a particular task, a user may, among other things, view information associated with the task (e.g., a description of the task, comments in an activity feed associated with the task, etc.) and/or interact with a the task (e.g., comment regarding the task, modify a status of the task, associate users with the task, upload documents associated with the task, etc.) within an interface providing the search query results.

In yet further embodiments, systems and methods may enable centralized administration of workspaces, collaborations, users, and/or other aspects of a collaboration and/or document management service consistent with embodiments disclosed herein through an administrator console interface. Using an administrator console interface a user may, among other things, control, view, and/or otherwise manage and/or management document storage, workspace creation, user and/or system licenses, service settings (e.g., password settings) and/or the like, and may further allow a user to perform various analytics in connection with the same.

Secure Cloud Information Management System

Systems and methods disclosed herein may provide for a Secure Cloud Information Management System (“SCIMS”) that may, at least in part, enable secure, governed, and/or audited collaboration and/or document management over cloud storage platforms (e.g., third-party cloud storage platforms). In certain embodiments, the SCIMS may provide a simple and effective way to securely utilize cloud and mobile computing resources and/or services, including cloud storage services provided by multiple third-party services. In some embodiments, a SCIMS may allow for electronic document creation using any preferred application and provide an architecture for, among other things, securing such a document, sharing the document with a cloud storage service (e.g., a third-party cloud storage service), securely distributing the document to others, and/or managing, controlling, and monitoring use of the document by others (e.g., monitoring the use of the document by designated individuals and/or groups).

In certain embodiments, a SCIMS may provide for secure document encryption whenever documents are not in use and/or management and control of document usage. Further embodiments of the SCIMS disclosed herein may provide for management and control of copying, forwarding, printing, editing, clipboard functions, and/or offline use of a document. A SCIMS may allow for access of documents at a variety of locations and/or provide for document versioning and reconciliation services. For example, a SCIMS may ensure that individuals collaborating on a document have the latest versions of the document for use while offline and/or make obsolete or outdated versions of the document unavailable.

In further embodiments, a SCIMS may include reporting functionality. For example, a SCIMS and/or a related system may be capable of providing reports on who accesses documents and how they are used. By using a SCIMS, a cloud and mobile computing environment may become a convenient and secure place to store, share, and/or manage documents and other enterprise information. Document creators and/or enterprises may maintain control over the security of their electronic information, ensuring that employees, colleagues, partners, and/or customers may access electronic information stored in the cloud system, while maintaining the ability to track, manage, and/or control the use of such electronic information by others.

Trusted Service and Cloud Storage System Ecosystem

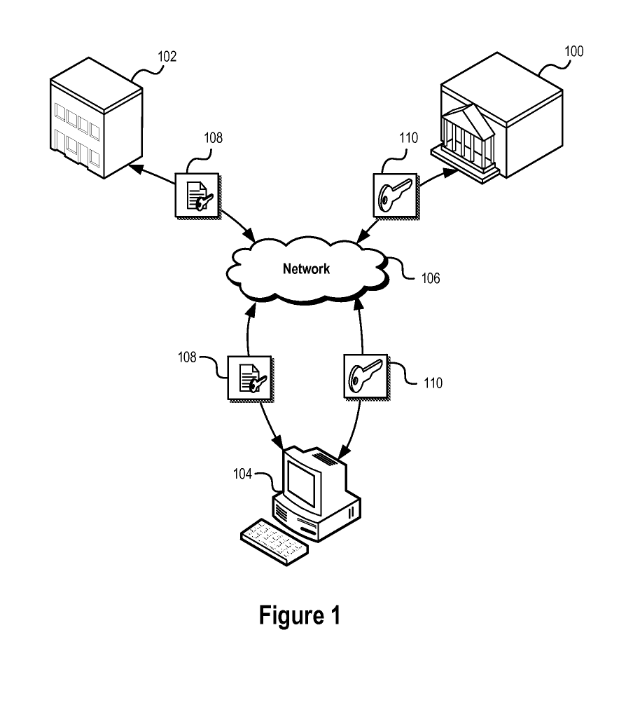

FIG. 1 illustrates an exemplary ecosystem including a trusted service 100 consistent with embodiments of the present disclosure. The trusted service 100 may provide a variety of functions including, without limitation, functions associated with a SCIMS. In certain embodiments, the trusted service 100 may be communicatively coupled with one or more client systems 104 via a network 106. The one or more client systems 104 may be communicatively coupled with a cloud storage service 102 via the network 106. In certain embodiments, the one or more client systems 104 may be associated with a service and/or an application or process that accesses information stored by the cloud storage service 102 to perform an operation. For example, an application executing on the client system 104 configured to analyze data may access such data from the cloud storage service 102.

The network 106 may comprise a variety of network communication devices and/or channels and may utilize any suitable communications protocols and/or standards facilitating communication between the trusted service 100, cloud storage service 102, and/or client system 104. The network 106 may comprise the Internet, a local area network, a virtual private network, and/or any other communication network utilizing one or more electronic communication technologies and/or standards (e.g., Ethernet or the like). In some embodiments, the network 106 may comprise a wireless carrier system, such as a personal communications system (“PCS”), and/or any other suitable communication system incorporating any suitable communication standards and/or protocols. In further embodiments, the network 106 may comprise an analog mobile communications network and/or a digital mobile communications network utilizing, for example, code division multiple access (“CDMA”), Global System for Mobile Communications or Groupe Speciale Mobile (“GSM”), frequency division multiple access (“FDMA”), and/or time divisional multiple access (“TDMA”) standards. In certain embodiments, the network 106 may incorporate one or more satellite communication links. In yet further embodiments, the network 106 may utilize IEEE's 802.11 standards, Bluetooth®, ultra-wide band (“UWB”), Zigbee®, and/or any other suitable standard or standards.

The trusted service 100, cloud storage service 102, and/or the client system 104 may comprise a variety of computing devices and/or systems, including any computing system or systems suitable to implement the systems and methods disclosed herein. The connected systems 100-104 may comprise a variety of computing devices and systems, including laptop computer systems, desktop computer systems, sever computer systems, distributed computer systems, smartphones, tablets, and/or the like.

In certain embodiments, the trusted service 100, cloud storage service 102, and/or the client system 104 may comprise at least one processor system configured to execute instructions stored on an associated non-transitory computer-readable storage medium. As discussed in more detail below, the trusted service 100, cloud storage service 102, and/or the client system 104 may further comprise a secure processing unit (“SPU”) configured to perform sensitive operations such as trusted credential and/or key management, secure policy management, and/or other aspects of the systems and methods disclosed herein. The trusted service 100, cloud storage service 102, and/or the client system 104 may further comprise software and/or hardware configured to enable electronic communication of information between the devices and/or systems 100-104 via the network 106 using any suitable communication technology and/or standard.

The cloud storage system 102 may be configured to distribute and/or manage electronic information stored therein. As used herein, the terms information, electronic information, documents, files, folders, electronic documents, and/or data may be used interchangeably. In certain embodiments, electronic information and/or documents may comprise structured application data (e.g., generated by applications utilizing the cloud storage system 102 for storing data). In further embodiments, electronic information and/or documents may comprise any other suitable electronic information, documents, and/or data generated by any type of service and/or application. In certain embodiments, a plurality of storage systems may be associated with the cloud storage system 102. Such storage systems may be located in a single location or, alternatively, be distributed in multiple locations. In some embodiments, the cloud storage system 102 may be associated with one or more third-party cloud storage providers such as Google Drive, Microsoft SkyDrive®, DropBox®, SugarSync®, iCloud®, and/or the like. In further embodiments, the cloud storage system 102 may be associated with the trusted service 100.

Consistent with embodiments disclosed herein, the trusted service 100 may operate in conjunction with the one or more client systems 104 and/or cloud storage service 102 to allow secure collaborative distribution and management of electronic information (e.g., documents or the like) stored on the cloud storage system 102. For example, in certain embodiments, systems and methods disclosed herein may utilize trusted credentials and/or certificates issued by a trusted authority to implement and enforce security and trust management architectures, allowing for secure distribution and management of electronic information and/or collaborations involving such information.

The trusted service 100 may be a trusted authority operating as a root of trust. In certain embodiments, the trusted service 100 may be configured to issue one or more trusted credentials 110 to other systems including, for example, the client system 104. In certain embodiments, the trusted service 100 may implement a variety of functions including, without limitation, system credentialing, trusted communication, authentication, authorization, key management, and/or policy management and enforcement operations. Although illustrated as a single system, the trusted service 100 may be performed by any other suitable system or combination of systems (e.g., as in distributed key management systems).

In some embodiments, prior to issuing a trusted credential 110, the trusted service 100 may verify and/or certify that a system (e.g., client system 104) is trusted. In certain embodiments, the trusted service 100 may verify that a system is trusted by verifying that software and/or hardware components included therein meet certain security requirements. For example, prior to issuing a trusted credential 110 to the client system 104, the trusted service 100 may verify that the client system 104 includes a secure processor system and/or incorporates a secure execution environment for handling secure information.

After verifying that the client system 104 meets certain trust and security requirements, the trusted service 100 may generate and distribute a trusted credential 110 via the network 106 to the client system 104. In certain embodiments, the trusted credential 110 may be generated using any suitable cryptographic techniques (e.g., techniques that utilize cryptographic hash algorithms and/or asymmetric cryptography). In further embodiments, a trusted credential 110 may comprise a cryptographic key. Any other suitable credential 110 operating as an indicia of trust may also be utilized. It will be appreciated that there are a variety of techniques for generating a credential, and that for purposes of practicing the systems and methods disclosed herein, any suitable technique may be used.

Possession of a trusted credential 110 (e.g., by client system 104) may have certain associated requirements. For example, the client system 104 may be required to store the trusted credential 110 in a secure manner so that it is not easily accessible, in order to maintain authorized possession of the trusted credential 110. Aspects of the use of the trusted credential 110 may have similar requirements. Such requirements may maintain the trustedness of the trusted credential 110 and may mitigate the potential for the trusted credential 110 to become compromised.

In certain embodiments, the trusted credential 110 may comprise a cryptographic key. The cryptographic key may be utilized by the client system 104 to access and/or utilize encrypted or otherwise protected information 108 (e.g., encrypted documents) provided to the client system 104 by the cloud storage service 102 via the network 106. For example, in certain embodiments, documents stored, managed, and/or distributed by the cloud storage system 102 may be encrypted. Upon receipt of an encrypted document 108 from the cloud storage service 102, the client system 104 may utilize a cryptographic key 110 provided by the trusted service 100 to decrypt and access the document.

Prior to transmitting the document from the client system 104 (e.g., to be stored remotely by cloud storage service 102), the client system 104 may encrypt the document. In this manner, the document may be provided to the cloud storage system 102 in an encrypted form. In certain embodiments, the cryptographic key 110 associated with the encrypted document 108 may not be provided to the cloud storage service 102, thereby offering a measure of security in the event the cloud storage service 102 is compromised.

By offering cryptographic services independent from the cloud storage system 102 and not disclosing trusted credentials and/or cryptographic keys 110 to the cloud storage system 102, risks associated with storing enterprise data in the cloud may be mitigated, as an attacker would need to compromise both the cloud storage system 102 and the client system 104 and/or the trusted service 100 to access encrypted documents stored by the cloud storage system 102. Furthermore, the risk of a data leak as a consequence of human error may also be reduced. For example, even if an authentication system associated with the cloud storage service 102 allowed an unauthorized user to login to an account associated with an enterprise, embodiments of the systems and methods disclosed herein may render any information obtained by the unauthorized user of little value, since the unauthorized user would not possess the cryptographic keys 110 required to access the encrypted document 108.

Client System Architecture

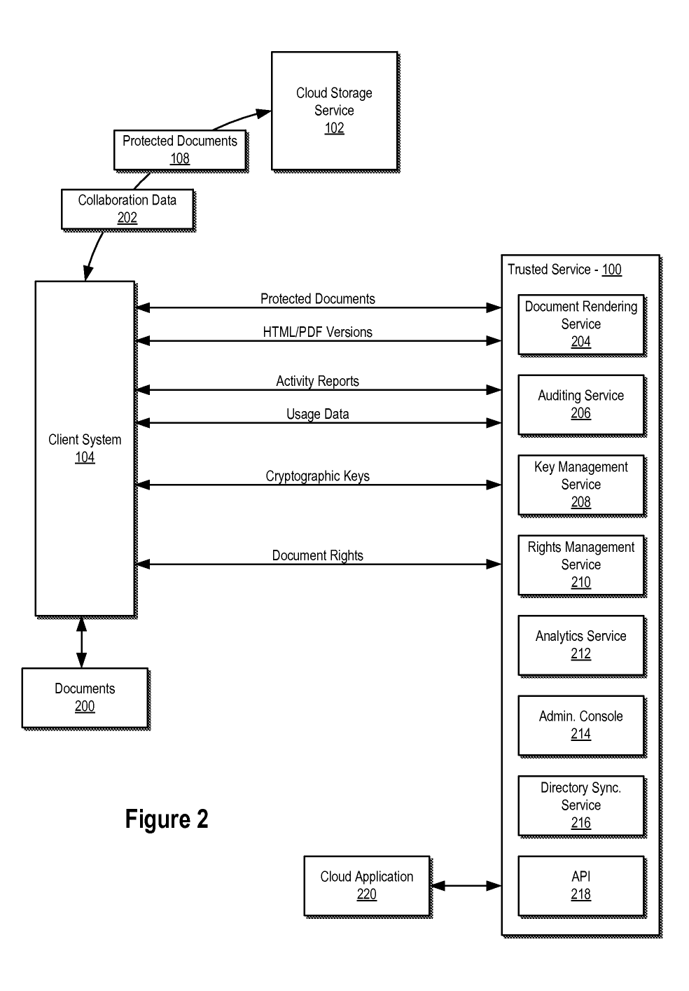

FIG. 2 illustrates an exemplary architecture of a client system 104 and a trusted service 100 consistent with embodiments of the present disclosure. In addition to the above-described cryptographic key-related operations (e.g., acquisition and use of cryptographic keys in the context of document decryption services and/or the like), the client system 104 may perform a variety of other operations relating to document management, governance, and/or control. In certain embodiments, the client system 104 may be configured to generate and/or enforce access and/or usage rights or other permission-related information associated with documents stored on and/or accessed by the client system 104. For example, the client system 104 may be configured to restrict access to a document after the expiration of a certain period, and/or enforce other policies associated with the document, client software, and/or user. Similarly, the client system 104 may be configured to restrict a user's ability to perform certain actions or operations on a document (e.g., copying, editing, saving, and printing operations, etc.) as expressed in access rights and/or permissions associated with the document.

The client system 104 may allow a user to generate, create, edit, modify, and/or otherwise interact with one or more documents 200. For example, in some embodiments, client system 104 may utilize one or more applications (e.g., word processing applications) to allow a user to generate documents 200 using client system 104. In certain embodiments, the client system 104 may enable document creation using one or more web-based applications that allow a user to create, review, and/or edit documents 200 without the installation of specialized third-party document creation and editing software.

The client system 104 may further facilitate exchanging protected documents 108 (e.g., documents protected by cryptographic methods or the like) with a cloud storage service 102 and/or other systems. For example, as described above, the client system 104 may perform certain cryptographic services including document encryption and/or digital signing. After encryption and/or signing, the resulting protected documents 108 may be shared with remote systems such as a cloud storage service 102.

In certain embodiments, the client system 104 may provide collaboration functionality that enables secure rights-based collaboration between one or more participants. In some embodiments, collaboration features may utilize, at least in part, document synchronization and/or sharing functions provided by the cloud storage service 102. Collaboration functionality may be realized through an exchange of documents having associated rights (e.g., rights expressed in information associated with the documents). Rights may express, among other things, what users may access a document and/or what types of access (e.g., viewing, editing, printing, etc.) are allowed. In certain embodiments, a user may use a software application utilized in creating or modifying a document to set and/or define rights associated with the document. In further embodiments, a collaboration application executing on the client system 104 may be utilized in setting or defining rights.

Additional collaboration functionality provided by the client system 104 may include sharing of copies of documents having associated access or access-restricted rights (e.g., view-only copies), check-in/check-out of documents (e.g., to prevent a user from overwriting another's changes to a document), document versioning and reconciliation services, and activity tracking allowing a user to comment and/or track the usage of a document and/or the actions of other collaborators (e.g., via activity streams or the like). In certain embodiments, collaboration data 202 including document and/or user activity reports and/or usage data may be exchanged between the client system 104, the cloud storage service 102, and/or the trusted service 100.

The client system 104 may further provide one or more visualization features configured to allow a user to view and/or understand how documents are distributed and used by others in collaboration. In certain embodiments, the client system 104 may provide a user with a graph (e.g., a directed node-link graph) illustrating how a document is forwarded and/or used by collaboration participants. In some embodiments, the graph may be generated by the client system 104 based on collaboration data 202, activity reports, and/or other usage data. Utilizing such a graph, a user may be able to determine, among other things, what users have opened, printed, and/or forwarded a document, and to whom. Selecting a node on the graph may provide information regarding, among other things, applied usage rules as well as attributes relating to users associated with the selected node. In some embodiments, selecting a link on the graph may provide information regarding, among other things, a date or mechanism of how the document was forwarded (e.g., e-mail, instant message, etc.).

In further embodiments, the client system 104 may provide task management functionality in connection with collaboration services. In some embodiments, task management features provided by the client system 104 may include, without limitation, task creation, task assignment to one or more participants, uploading and/or otherwise associating one or more documents and/or files in connection with a task, assigning and/or changing a status of a task (e.g., task pending, task completed, etc.), and/or the like. In certain embodiments, various activities performed in connection with tasks may be tracked and/or otherwise audited and displayed in connection with social communication features of a collaboration service (e.g., via activity streams or the like). In some embodiments, social communication and task management features may be integrated in a single activity stream and/or similar feed, thereby facilitating more efficient task organization and/or coordination.

The client system 104 may further provide search functionality in connection with the disclosed collaboration and/or document management services. Using such search functionality, a user may, among other things, identify search results including workspaces, users, documents, files, folders, tasks, comments, and/or any other type of information used in connection with the disclosed collaboration and/or document management services fulfilling certain search criteria (e.g., a search query). In some embodiments, the search results may be active, allowing a user to interact with the results in a variety of ways from a search results page of an interface of the client system 104. Providing active search results may, among other things, allow a user to interact with various features and/or aspects of the disclosed services directly from a search results page, thereby increasing efficiency and/or ease of use the disclosed systems and methods.

In some embodiments, the client system 104 may further be used in connection with administering of various features and/or functions of the disclosed collaboration and/or document management services. For example, an administrator console interface provided by the client system 104 may allow a user having certain authority and/or authorization to, among other things, control, view, and/or otherwise manage and/or management document storage, workspace creation, user and/or system licenses, service settings (e.g., password settings) and/or the like. The administrator console interface may further allow a user to perform various analytics in connection with the same.

Trusted Service Architecture

The trusted service 100 may include a plurality of services to support activities of the client system 104. For example, the trusted service 100 may include an administrative console 214 configured to manage subscribers to the trusted service 100. The trusted service 100 may further include an analytics service 212 configured to provide various document, user, and usage analytics functions. For example, the analytics service 212 may track, consolidate, analyze, and/or operate on documents, activities, and trends across documents associated with an enterprise. Using information provided by the analytics service 212, a user of the client system 104 and/or the trusted service 100 or an enterprise administrator may analyze documents and their usage.

An application programming interface (“API”) 218 may allow the trusted service 100 to interface with one or more cloud applications 220. For example, via an API 218, the trusted service 100 may interface with a cloud application 220 executing on the client system 104 configured to facilitate interaction between the client system 104 and the cloud storage service 102 and/or the trusted service 100. Embodiments disclosed herein may further provide an application store for hosting applications for sale utilizing the systems and methods disclosed herein. A directory synchronization service 216 may synchronize with a directory associated with an enterprise (e.g., an employee directory) and facilitate authentication of users associated with the enterprise with the trusted service 100.

A document rendering and/or editing service 204 may be configured to facilitate one or more document rendering and/or editing functions. For example, a document rendering and/or editing service 204 may allow for the conversion and exchange of documents of particular file-types (e.g., HTML, PDF, or the like) and/or the enforcement of rights associated with such documents. For example, in certain embodiments, the document rendering and/or editing service 204 may generate read-only versions of documents configured to be viewed through a web-browser (e.g., without the use of native editing software applications). Similarly, the document rendering and/or editing service 204 may utilize suitable mechanisms including, for example, JavaScript, to prevent certain actions from being performed on a document (e.g., preventing printing or copying portions of the document to a clipboard).

The trusted service 100 may further provide auditing services 206 enabling audited collaboration. For example, auditing or activity reports and/or usage data may be provided by the client system 104 and/or the cloud storage service 102 to the trusted service 100 that may enable tracking of how a document is used and by whom. For example, certain documents may be associated with policies that allow them to be freely forwarded. Auditing services 206 may receive and/or maintain information regarding identities (e.g., e-mail addresses) of users who have opened a copy of the document, users who have printed the document, and/or the like. Using such information, auditing services 206 may provide a user (e.g., a document creator) an indication as to how a document has been distributed and used over time. In certain embodiments, such an indication may be provided in a visual graph and/or animation. In further embodiments, auditing services 206 may be utilized by an enterprise administrator to identify and/or detect suspicious usage behavior and/or document access patterns.

As discussed above, in certain embodiments, access and/or usage rights or other permission-related information associated with documents may be utilized to manage and/or control access. A rights management service 210 included in the trusted service 100 may perform various rights management-related functions enabling the management and enforcement of various usage and/or other access rights associated with documents. For example, using the rights management service 210, a user may be able to set and/or define document rights that may be exchanged between the client system 104 and the trusted service 100 used in rights enforcement operations.

A key management service 208 may perform trusted credential and/or key management services offered by the trusted service 100. For example, as discussed above, the trusted service 100 may generate and distribute trusted credentials and/or cryptographic keys to a client system 104 used in accessing protected documents 108. In addition to key distribution-related services, the key management service 208 may perform certain trust verification operations to ensure a client system 104 is trusted prior to distributing a trusted credential and/or cryptographic key to the system.

In some embodiments, the systems and methods disclosed herein for enabling secured, governed, and/or audited collaboration and/or document management over cloud storage platforms may allow for, without limitation, some or all of the following:
Reduced enterprise risk associated with storing documents with a cloud storage service 102.
Reduced implementation and maintenance costs afforded by leveraging the expertise and infrastructure of third-party cloud storage providers.
Increased user flexibility in terms of selection and/or changing of cloud storage providers. For example, embodiments disclosed herein may allow users to move seamlessly across multiple cloud storage providers while maintaining the security and rights associated with their documents.
Integration with a variety of cloud service applications. For example, embodiments disclosed herein may allow for integration of features provided by a trusted service into an existing cloud service provider application.
Visualization of governed distribution using static and/or animated graphs (e.g., directed graphs) that may illustrate the distribution and use lifecycle of a document.
Tracking of document usage and reporting of usage to a document owner, creator, and/or other interested parties. For example, a document owner may be provided with a notice when a document has been forwarded to a third-party (e.g., an unauthorized third-party) and/or in the event unusual document usage or activity patterns arise.
Flexible separation of documents and associated rights. For example, a document may be associated with an XML structure that expresses an access/collaboration/rights list associated with the document. The structure may be stored separately from the document itself. A key management service may provide cryptographic keys used to access and/or decrypt the document, while a collaboration and/or rights management service may provide access/rights lists for the document. This may allow for document storage across multiple storage providers, while ensuring secure and seamless collaboration.

Collaboration System Interface

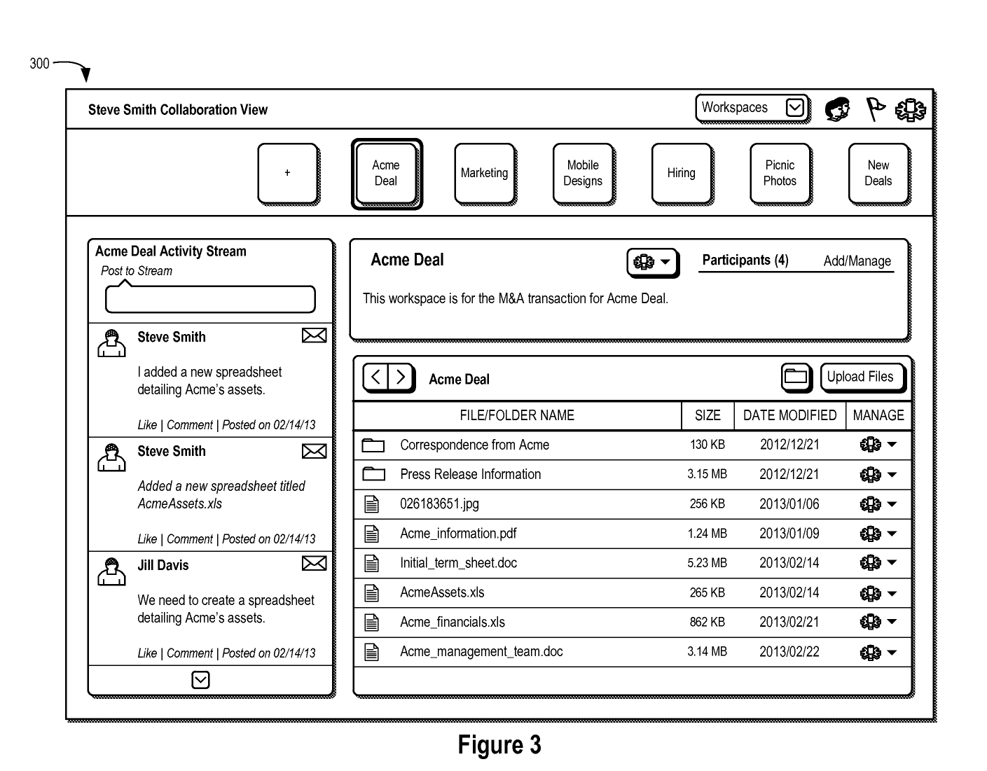

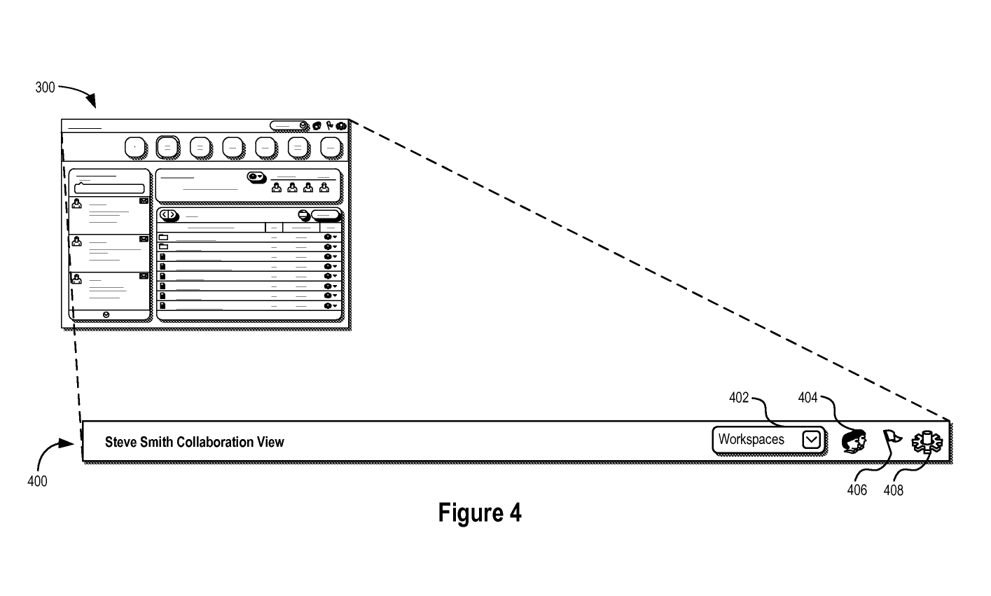

FIG. 3 illustrates an exemplary interface 300 for interacting with a collaboration system consistent with embodiments of the present disclosure. In certain embodiments, the exemplary interface 300 may be associated with a cloud storage service provider and/or a trusted service as described herein. In further embodiments, the exemplary interface 300 may be an interface of an application executing on a client system interacting with a cloud storage service provider and/or a trusted service. In certain embodiments, the interface 300 may be an HTML5-based interface displayed, for example, in a web-browser application. In further embodiments, the interface 300 may be a mobile device interface, a computer system application interface (e.g., a desktop application interface), an interface of a plugin for one or more third-party applications (e.g., an email program, word processing program, office suite of programs, etc.), and/or any other type of interface. In some embodiments, the interface 300 may mirror and/or be an interface of a third-party cloud storage service provider while, in other embodiments, the interface 300 may be a uniform interface across third-party cloud storage service providers. Certain elements of the exemplary interface 300 are illustrated and described in more detail below in reference to FIGS. 4-11.

In certain embodiments, a user may log in to a collaboration system associated with the interface 300 via any suitable authentication and/or credentialing method (e.g., username/password authentication or the like). Once logged in to the collaboration system, the user may utilize and/or perform a variety of collaboration and/or document management-related operations using the interface 300. For example, a user may navigate between one or more workspaces associated with groups of documents and/or users participating in collaboration. Using the interface 300, a user may upload documents to a cloud storage system associated with the collaboration system. A user may further navigate and/or browse one or more previously uploaded documents associated with a workspace. The user may define rights and/or permissions information associated with uploaded documents. Rights and/or permissions information may be enforced by the collaboration system to restrict certain operations from being performed on documents by certain users (e.g., editing, forwarding, and deleting operations and/or the like). As discussed in more detail below, rights and/or permissions information may be role-based, with users having certain rights and/or permissions based on one or more defined roles. A user may perform various operations on a document via the interface 300 and/or an associated application (e.g., a third party word processing application and/or the like).

A user may forward documents to other collaboration participants and/or third parties via one or communication mechanisms integrated in the interface 300 and/or via one or more applications (e.g., an e-mail client application). In certain embodiments, users may publish comments on activity within a workspace via an activity stream that may incorporate @mentioning and hash tag functionality. The activity stream may further display updates based on certain events within a workspace (e.g., document uploads, forwarding, edits, login events, and/or the like). Using the interface 300, a user may view usage information and/or a usage history associated with a document. In certain embodiments, a user may view a visual usage history (e.g., a node-link graph) associated with a document indicating various operations performed on the document and by whom. A user may further follow a document uploaded to the collaboration system. For example, a user may be provided with updates when certain operations are performed on a document they are following (e.g., edits, forwarding, etc.) These and other functions and operations associated with various embodiments of the interface 300 and/or an associated collaboration system are described in more detail below.

FIG. 4 illustrates a top menu 400 of an exemplary interface 300 for interacting with a collaboration system in accordance with some embodiments of the present disclosure. The top menu 400 may provide an indication of what is displayed in the interface 300. For example, as illustrated, the top menu 400 may provide an indication that the interface 300 provides a view of a collaboration associated with a particular user (e.g., “Steve Smith Collaboration View”). A user may login to an application associated with a cloud storage system and/or trusted system and be provided with the interface 300. In certain embodiments, a user may login using credentials unique to the cloud storage system and/or the trusted system. In further embodiments, a user may login using credentials associated with a third-party service (e.g., a social media service or the like). In such embodiments, profile information and/or contact information associated with the third-party service may be imported into the system when the user logs in with the third-party system credentials.

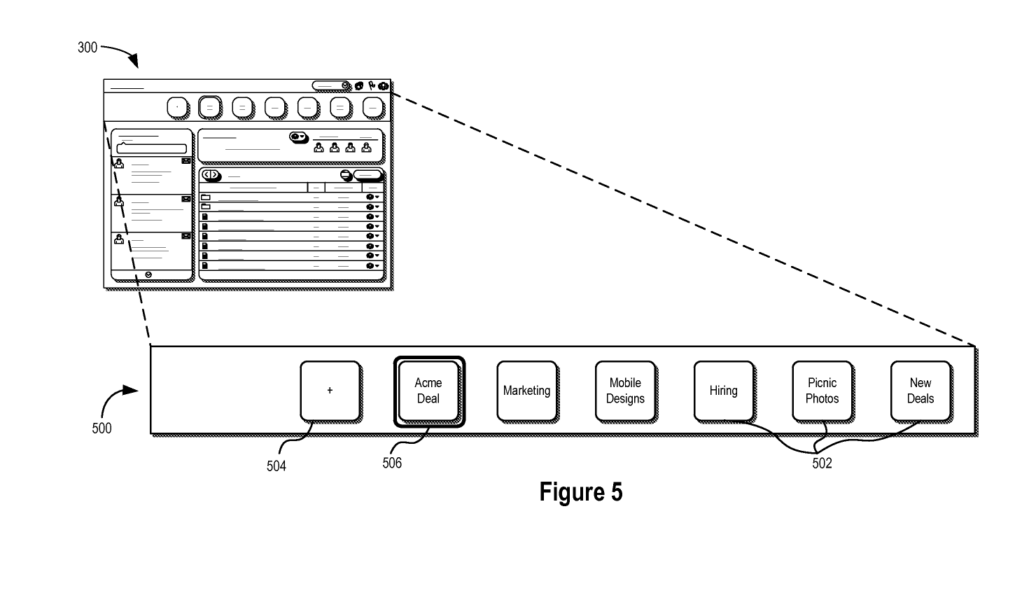

In some embodiments, a user may toggle between one or more navigator views (e.g., a workspace navigator view as described below in reference to FIG. 5) using navigator button(s) 402. In certain embodiments, selecting the navigator button(s) 402 or a portion thereof may provide a menu (e.g., a drop-down menu) allowing a user to select from one or more navigator views. A user may further set one or more notifications relating to a workspace and/or a collaboration by selecting a notification icon 406. Selecting the notification icon 406 may provide a user with a menu allowing for one or more notifications to be set. For example, a user may set a notification rule expressing that when a change to a document in a workspace and/or collaboration is made, an e-mail message notifying the user of the change will be automatically generated. The top menu 400 may further include a settings icon 408. When selected, the settings icon 408 may provide a user with a menu allowing him or her to select and/or change various settings and/or configurations relating to the interface 300.

User Profiles

In certain embodiments, a user may login by selecting a user profile and/or login icon 404, and providing user authentication information identifying the user. In certain embodiments, the identification information may comprise a username, an e-mail address, and/or any other suitable identification. It will be appreciated that any other suitable login and/or authentication mechanism or combination thereof may be utilized, including a standard login, a login with a password policy, face or other biometric recognition, and/or the like. Additionally, a user may add, remove, and/or modify personal profile information by selecting the user profile and/or login icon 404 including, without limitation, a user's name, contact information, position within an enterprise, personal photo, and/or the like. Such personal profile information may be used by others in a collaboration to identify and/or contact a user.

A user may have a profile page that, in certain embodiments, may be visible to other users. Users may edit and/or manage information included in their profile page. In some embodiments, users may be able to edit and/or manage different information included in their profile page based on user credentials and/or permissions associated with the user. For example, in certain embodiments, a user with unrestricted access rights may be able to edit all types of information included in their profile page, whereas a user with restricted access rights may be able to edit a subset of the information. In some embodiments, permissions are associated with viewing profile information. For example, internal company information, such as details that might reveal information about the company's organizational structure, may not be visible to a collaborator outside the organization. In further embodiments, profile information may be generated by accessing one or more third-party services and/or directories (e.g., an enterprise directory, a social media service, and/or the like). The profile page may provide a central place to contact and/or learn information about the user and/or his or her role within an enterprise or a collaboration.

Profile information associated with a user may include, without limitation, some or all of the following:
Name (e.g., first and/or last).
Photo (e.g., a user-uploaded photo).
An indication of collaborations the user is participating in.
A biography.
A job title and/or role.
An associated company and/or enterprise.
User expertise information.
Third-party application contact information (e.g., instant messaging IDs, social network IDs, and/or the like).
Contact information (e.g., e-mail addresses, phone numbers, etc.).

It will be appreciated that a variety of other information may be included in a user's profile information.

Contact Lists

In some embodiments, users may maintain contact lists in connection with a collaboration system. Contact lists may be managed in a variety of ways. For example, contact lists may be synchronized with, and/or utilize information from, one or more directory services (e.g., enterprise directories) that may be associated with third-party services integrated with the collaboration system. Users may also enter contact information for other users into a contact list via the collaboration system. It will be appreciated that a variety of systems and methods may be used to generate contact lists and/or contact information, and that for purposes of practicing the systems and methods disclosed herein, any suitable systems and methods may be used.

Workspaces

In some embodiments, systems and methods disclosed herein may utilize workspaces. A workspace may function as a logical top-level container or folder for one or more documents and/or folders associated with particular project or collaboration. Workspaces may be arranged and/or grouped in any suitable order or manner (e.g., nested or the like). In certain embodiments, a workspace may be associated with a collaborative project involving multiple users and/or participants. In further embodiments, a workspace may be associated with a single user (e.g., a private workspace). A workspace may be identified by a unique name and/or creator. In further embodiments, workspaces having the same name may be identified based on other identifying indicia (e.g., an associated creator or the like). As used herein, the terms workspace and collaboration may be used interchangeably.

FIG. 5 illustrates an example workspace navigator 500 of an exemplary interface 300 for interacting with a collaboration system consistent with some embodiments of the present disclosure. The workspace navigator 500 may provide a user with a collection of workspaces 502. In certain embodiments, one or more of the workspaces 502 may be associated with a single user. In further embodiments, one or more the workspaces 502 may be associated with multiple users in a collaboration.

In some embodiments, workspaces 502 may be shown using one or more different icons. In certain embodiments, a workspace 502 may be shown using an icon relating to the content of a workspace. Icons associated with workspaces 502 may vary (e.g., vary in color, font, shape, or the like) based on a category of an associated workspace. In further embodiments, icons may vary based on whether a workspace 502 is associated with a single user or multiple users, based on a creator and/or owner of the workspace 502 (e.g., workspaces created by a corporate IT department may have different icons than other departments), based on whether a workspace 502 is a private workspace for a user's personal documents, and/or the like In yet further embodiments, workspaces 502 containing documents that are synchronized to a latest version, are in the process of being synchronized, are opened for editing, are opened for editing but are outdated, and/or any other suitable workspace status may be displayed on the interface 300 in a way that is visually distinguishable.

A user may add a workspace 502 by selecting an add workspace icon 504. In some embodiments, selecting the add workspace icon 504 may provide a menu allowing a user to enter various settings relating to a new workspace (e.g., workspace name, participants, participants rights/roles, rules and/or settings relating to the workspace, and/or the like). If a user already has a workspace with the same name as a new workspace they wish to create, they may be prompted to modify the new or prior workspace name. After creating the workspace, the new workspace may be shown in the workspace navigator 500.

A user may further delete a workspace 502 by selecting the workspace (e.g., by right clicking a workspace) and a delete workspace option. For example, by selecting a workspace 502 with a right click, a user may be provided a menu with various options relating to the workspace that includes a delete option. In certain embodiments, deleting a workspace 502 may delete the workspace for all users and/or participants in the workspace. Accordingly, in some embodiments, the ability to delete a workspace may be limited to users with certain associated permissions and/or roles (e.g., creators, editors, etc.). In further embodiments, deleting a workspace 502 may not delete the workspace for other users, by may remove the workspace from the workspace navigator 500 for the user deleting the workspace. In certain embodiments, the user may be prompted to confirm intent to delete a workspace. In some embodiments, when a workspace has been deleted by a user, other users collaborating on the workspace may receive a notification (e.g., an e-mail notification or the like).

A user my select a particular workspace (e.g., “Acme Deal”) from the workspace navigator 500. When a workspace is selected, an indication 506 may be shown in connection with the selected workspace. Any suitable indication may be used to indicate a selected workspace in the workspace navigator 500 (e.g., highlighting and/or changing a color of a selected workspace icon, changing a border of a selected workspace icon, circling a selected workspace icon, and/or the like). When selected, information associated with the selected workspace may be shown in the interface 300.

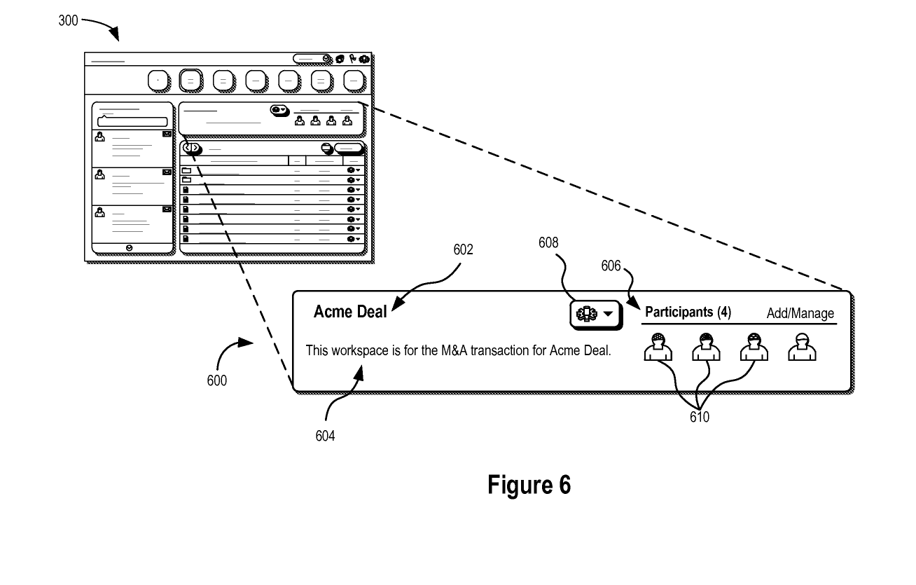

FIG. 6 illustrates a workspace menu 600 of an exemplary interface 300 for interacting with a collaboration system consistent with some embodiments of the present disclosure. The workspace menu 600 may provide a variety of information relating to a selected workspace. For example, as illustrated, the workspace menu 600 may provide an indication of a workspace name 602 and/or a description of the workspace 604. In certain embodiments, the workspace name 600 and/or description 604 may be provided by a creator and/or an administrator of the workspace.

The workspace menu 600 may provide an indication of one or more participants 600 collaborating on a workspace. For example, the workspace menu 600 may provide one or more participant icons 610 associated with participants collaborating on the workspace. In certain embodiments, the icons 610 may include participant names. In further embodiments, the icons 610 may include a photograph or other graphic or icon associated with a participant. In some embodiments, displayed information associated with a participant may be generated based on information included in an enterprise directory.

Using the workspace menu 600, a user with appropriate access control roles (e.g., creator, editor, etc.) may add and/or manage participants collaborating on the workspace. In some embodiments, a user may add participants by selecting names from an address book (e.g., an address book associated with an enterprise directory). For example, a collaboration system consistent with embodiments disclosed herein may integrate with third-party applications (e.g., electronic mail programs, other office productivity software, and/or the like) and utilize directories associated with the third-party applications to facilitate adding and/or managing participants collaborating on a workspace. A user with an appropriate access control role may similarly remove participants from a workspace, thereby restricting their access to documents associated with the workspace.

In some embodiments, adding a participant to a workspace may generate an e-mail invitation for the participant to register with the collaboration system and join the workspace. In further embodiments, if a participant is already registered with the collaboration system, the participant may receive a notification (e.g., an e-mail notification or the like) upon being added to a workspace. Before being added to a workspace, a user may need to pass certain personal authentication and/or system verification requirements.

A workspace settings icon 608 may be selected by a user, providing a user with one or more menus allowing the user to add/remove/manage settings associated with a workspace. For example, a user may be able to change a name and/or a description of a workspace, assign roles to participants of a workspace, change access controls and/or other rights-related settings for documents associated with the workspace, and/or manage any other relevant settings relating to a workspace.

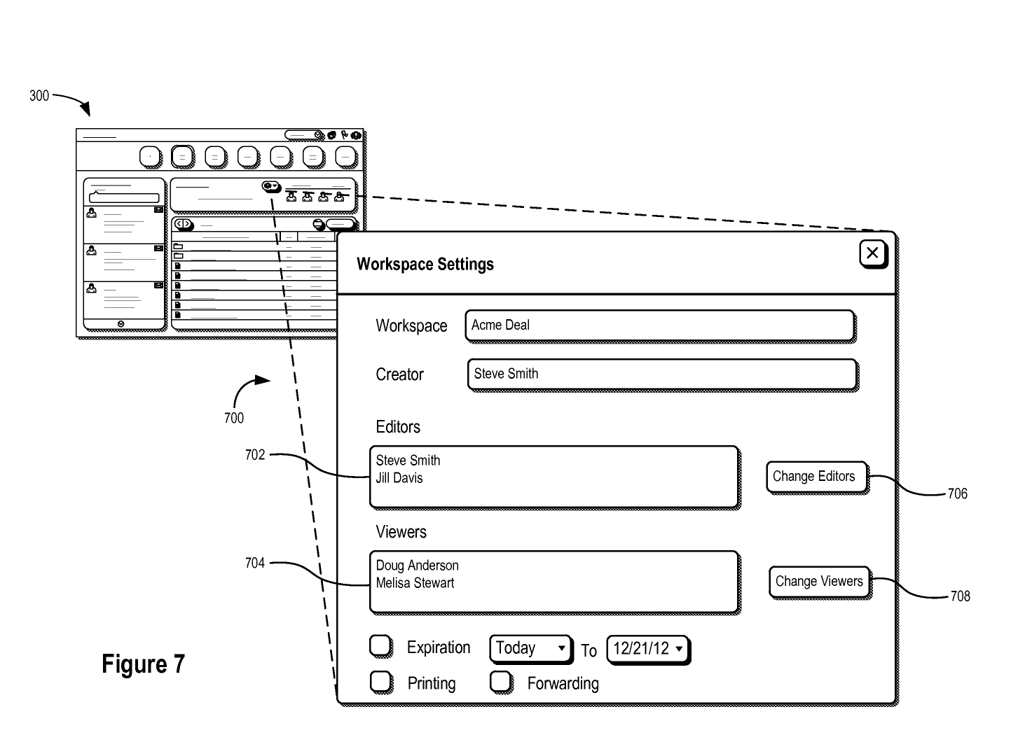

FIG. 7 illustrates a workspace settings menu 700 of an exemplary interface 300 for interacting with a collaboration system consistent with some embodiments of the present disclosure. In certain embodiments, the workspace settings menu 700 may be accessed by selecting a workspace settings icon included in the interface 300. Using the workspace settings menu 700, a user may be able to manage various settings associated with a workspace. For example, a user may be able to change a name and/or a description of a workspace.

Participant Roles and Workspace Permissions

Using the workspace settings menu 700, a user may further manage and/or assign roles to participants collaborating in a workspace. A workspace may have certain associated rights that may be dynamically modified. In certain embodiments, such rights may be associated and/or enforced with documents included in the workspace. In some embodiments, rights associated with a workspace may be associated with participants based on roles assigned to the participants by an authorized user (e.g., a workspace creator). Participant roles and associated rights may, for example, include, without limitation, some or all of the following exemplary roles:
Editor—An editor may be allowed to view and modify documents associated with the workspace (e.g., viewing, editing, and/or deleting documents in a workspace).
Owner—An owner may have similar rights as an editor but may also modify rights and/or various settings associated with the workspace (e.g., managing participant roles, workspace settings, and/or the like).
Viewer—A viewer may be allowed to view documents associated with the workspace in accordance with governance rules associated with the workspace and/or documents contained therein.
Excluded—An excluded user may be prevented from joining a workspace as a participant and/or from accessing any information included in the workspace.

It will be appreciated that a variety of roles having a variety of associated rights and/or permissions may be assigned to workspace participants, and that for purposes of practicing some embodiments of the systems and methods disclosed herein, any suitable number and/or types of participant roles and rights may be used.

In some embodiments, group association for workspace participants may be provided, wherein a group of participants can be assigned a role. In such embodiments, affiliation with a group may determine rights associated with the constituent users. For example, access rights and/or permissions associated with a document may allow users in a group to perform certain actions on the document (e.g., a document locked by an authorized user in a group may be unlocked by another authorized user of the group). In this manner, adding a user to a group will provide them with rights associated with the group. In certain embodiments, all users of an enterprise may be assigned an excluded role until they are granted a role by an authorized party (e.g., a workspace creator).

Workspace participants assigned particular roles may be displayed in the workspace settings menu 700. For example, participants assigned editor roles 702 and viewer roles 704 may be displayed. Roles may be managed by an authorized user by selecting one or more buttons 706, 708 that may allow the user to add or remove users and/or groups assigned particular roles within the workspace (e.g., via menu or other suitable mechanism).

Participant roles and/or workspace permissions may be set to a default set of roles and/or permissions when a workspace is created. The workspace settings menu 700 may allow for creating, changing, and/or managing rights and/or workspace permissions associated with the workspace and/or participant roles. For example, an authorized user may assign start/end dates for certain assigned user roles. Further, an authorized user may assign and/or modify certain rights and/or permissions associated with participants, roles, and/or a workspace. In some embodiments, permissions may include, without limitation, some or all of the following:
Workspace settings management permissions allowing an associated user to change workspace settings.
Write permissions allowing users to, e.g., read, edit, name or rename, delete, and/or move a document in the workspace.
Invite permissions allowing users to invite others to join the workspace.
Forwarding permissions allowing users to forward documents included in the workspace, links to the documents, previews of the documents, and/or the like.
Printing permissions allowing users to print documents included in the workspace.

It will be appreciated that a variety of rights and/or permissions may be assigned to workspace participants and that for purposes of practicing some of the systems and methods disclosed herein, any suitable number and/or types of rights and/or permissions may be used.

Document Navigation

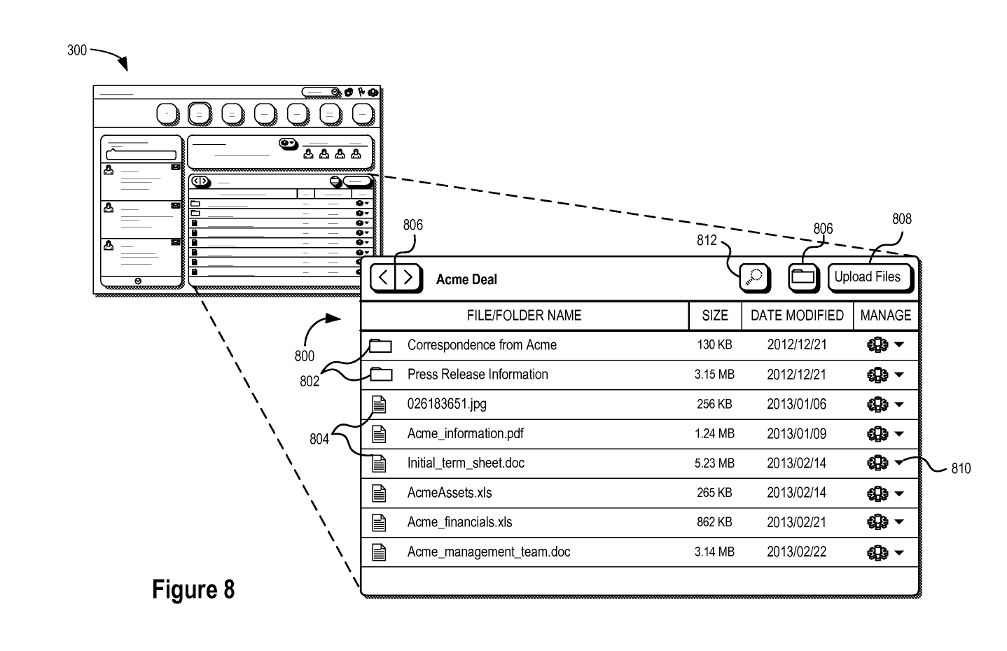

FIG. 8 illustrates a document navigation menu 800 of an exemplary interface 300 for interacting with a collaboration system consistent with embodiments of the present disclosure. The document navigation menu 800 may provide various file management functionalities. In certain embodiments, the documentation navigation menu 800 may display documents 804 associated with a workspace and allow users to browse and/or manage the documents. In further embodiments, the document navigation menu 800 may display folders 802 associated with a workspace and allow users to browse and/or manage the folders 802 and/or documents included therein. In some embodiments, the documentation navigation menu 800 may utilize native file browsing and management applications included in a client system (e.g., applications like Microsoft Explorer®, Apple Finder®, or the like) to provide various file browsing and management functions.

In some embodiments, the documents navigation menu 800 may, for example, provide, without limitation, some or all of the following functions:
View toggling (e.g., toggling between thumbnail views, list views, path views, and/or the like using a view toggling button 806).
Nested folders.
Drag and drop interaction (e.g., from a desktop or the like).
New folder creation (e.g., using a new folder button 806 or the like).
File and/or folder uploading (e.g., using a file upload button 808 or the like).
File and/or folder deletion.
File and/or folder renaming.
Cut, copy, and/or paste operations.
File moving operations.
Document settings management (e.g., using a settings icons 810 or the like) including, for example, management of rules and/or rights associated with a document.
File storage and search using document content and/or metadata information including, without limitation, file name, extension, date modified, size, last edit date, file type, last opened data, last user to open or update, and/or the like.
Searching operations (e.g., using a search button 812 or the like).

Different participants in a workspace may be shown different files and/or folders in the document navigation menu 800 based on their assigned roles. For example, participants without access rights to certain documents or folders may not see such documents or folders in the document navigation menu 800. In certain embodiments, a participant's access rights associated with a particular file or folder may be displayed in the document navigation menu 800 (e.g., via an indication that a user has editing rights to a document or the like).

Documents and/or files may be uploaded and downloaded from the workspace via the document navigation menu 800 in a variety of ways. For example, documents can be uploaded and downloaded from a local desktop. In some embodiments, a user may add or update a document by selecting file upload button 808. In certain embodiments, only users having particular roles may be allowed to add and/or update documents (e.g., owner or editor roles).

A user may select a document to upload (e.g., via a desktop navigation window or the like). If the user is in the process of editing a document, they may be provided with a notification that their edits may be lost if they proceed with uploading the document without saving. If a document is in the process of being edited by another user, they may be provided with a notification that the document may not be uploaded at that time. In certain embodiments, a user may be prompted to provide comments to associate with documents being uploaded that may be displayed to participants in the workspace (e.g., “Adding latest financial reports from accounting firm” or the like). In some embodiments, the user may specify one or more tags (e.g., hash tags) or keywords that may be used to locate the document. Once uploaded, the documents may be synchronized to all workspace participants. In certain embodiments, the participants may receive a notification (e.g., an e-mail message) indicate that the document has been uploaded. For example, participants may receive an e-mail including comments associated with an uploaded document and an identification of the document.

In certain embodiments, to delete documents from a workspace, a user may select a document to delete and select a delete menu option and/or press a delete key. In some embodiments, only users having particular associated roles (e.g., owner or editor) may delete documents from a workspace. If another user has a document opened for editing, a user wishing to delete the document may be provided a notification that the document is locked for editing and may not be deleted. Otherwise, the user may be requested to confirm the deletion. In some embodiments, a user may be prompted to provide comments to associate with a deletion action (e.g., “Deleting last year's financial report”). In further embodiments, a user may be provided an option to delete a document from a workspace but retain a copy locally. Workspace participants may receive a notification (e.g., an e-mail message) indicating that the document has been deleted. For example, participants may receive an e-mail including comments associated with a deletion action and an identification of a deleted document.

A participant may be able to locate documents associated with a workspace through a search function included in interface 300 (e.g., by selecting a search button 812 or the like). In some embodiments, searching may be performed using a variety of document attributes including, without limitation, some or all of name, creator, editors, content, associated comments, and/or the like. In some embodiments, document searching may not be limited to documents associated with a particular workspace, but may be inclusive of documents associated with other workspaces. If a search results in a document not in a selected workspace, the search results may provide an indication of a workspace the document is associated with.

Document Rights and Rules

In some embodiments, a variety of usage rights and/or rules can be associated with documents. In certain embodiments, usage rights and/or rules may be generated by document creators and/or users having certain associated roles within a workspace. In some embodiments, usage rights and/or rules may be associated with one or more actions relating to a document. For example, a rule may be associated with a document that enables copy and paste actions to be performed on the document but prevents editing or deletion actions. Similarly, a rule may be associated with a document expressing that when the document has been stored offline and is opened, a check for an updated copy is performed. In embodiments utilizing mobile devices, rules associated with a document may require that an update receipt be received before a document is displayed. It will be appreciated that a variety of rights and/or rules associated with a document may be utilized, and that for purposes of practicing the systems and methods disclosed herein, any suitable rights and/or rules may be used.

In certain embodiments, enterprise administrators may access and modify the rights and/or documents associated with a workspace under the enterprise's control. Further, enterprise administrators may be capable of backing up and/or restoring workspaces and associated documents, and may influence and/or restrict the process for approving participants collaborating on a workspace that are not part of the enterprise. In certain embodiments, an enterprise policy set by enterprise administrators may control whether collaboration participants may permanently delete documents and/or workspaces.

Document Viewing and Editing

When a user wishes to view a document, a user may select a document in the document navigation menu 800 (e.g., by double-clicking a document or selecting a view document menu option). The document may be opened and or viewed in an application where rules and/or rights associated with the document and/or the user's role may be enforced. In certain embodiments, a native application included on a client system in which the document was created (e.g., a word processing application such as Microsoft Word® or the like) may be utilized in viewing the document. In further embodiments, a viewing application associated with the interface 300 may be used to view a document. If permitted by rights and/or rules associated with the document, a user may edit the document, print the document, and/or perform other desired and allowed actions on the document.

In some embodiments, when a user wishes to edit a document, a user may select a document and provide an indication that they wish to edit the document (e.g., by selecting an edit document menu option or the like). A user may be prompted whether they wish to open a document for exclusive editing (e.g., where other participants cannot edit and/or update the document). In certain embodiments, a native application included on a client system in which the document was created may be utilized in editing the document. In further embodiments, a user may be prompted to select an application they wish to use to edit the document.

In some embodiments, when a document is being edited by a user, a visual indication indicating the same may be provided in the document navigation menu 800. For example, a document being edited by a user may be highlighted, thereby notifying other workspace participants of the status of the document. In certain embodiments, workspace participants may be able to select a document and be provided a list of other users editing the document. In some embodiments, a user may save a document locally and edit it at a later time. In further embodiments, a document may be distributed to multiple devices associated with a user, enabling the user to edit the document from any suitable device.

When a user is done editing a document, a user may publish the updated document to the workspace (e.g., by selecting a publish document menu option or the like). In certain embodiments, if a prior version of the updated document is being edited and/or viewed by another workspace participant, a notification of the updated document being uploaded may be provided to the workspace participant using the prior version, and/or to all of the other participants. Further, if a prior version of the updated document has been deleted from the workspace, the updated version may be re-added to the workspace. After the updated document has been published to the workspace, the updated version may be synchronized to all participants in the workspace.

Document Synchronization

When a user uploads, modifies, and/or deletes a document, the operation may be synchronized and reflected for all participants in a workspace. In certain embodiments, participants may be notified when a document is being synchronized (e.g., by a notification message in a task bar, a visual indication in the document navigation menu 800, or the like). In certain embodiments, if conflicting versions of a document are uploaded, a visual indication of the conflicting versions may be provided in the document navigation menu 800.

In some embodiments, document synchronization may be triggered manually on mobile devices. For example, due to storage and/or communication bandwidth limitations on mobile devices, decisions may be made (e.g., as expressed and/or enforced by associated rules) as to which updated and/or synchronized documents should be downloaded and cached and which should be fetched on demand. In some embodiments, a visual indication may be provided on the mobile device as to whether a document is cached and/or whether a cached document is outdated and an updated version is available for download.

In further embodiments, workspace participants may have access to all prior versions of a document included in a workspace. Users having particular roles (e.g., owners, editors, and/or the like) may perform certain operations on prior versions of a document including, for example, restoring a prior version and/or a deleted document. Some embodiments may provide support for sophisticated multiuser versioning and synchronization, active documents and forms with fine grained controls (e.g., allowing for selective modification of documents), security by overlying document passphrases with key backup and diversified key servers (e.g., requiring access to two or more servers to obtain a document key), security modules to decrypt and/or re-encrypt keys and/or documents in local storage, and/or tools for creating groups, synchronizing with third-party application contact lists and directories, and/or the like.

Document Distribution and Forwarding

In some embodiments, to forward a document, a user may select a document and provide an indication that they wish to forward the document (e.g., by selecting a forward document menu option or the like). A document forwarding menu may be provided to the user that allows the user to forward the document to a recipient. In some embodiments, a recipient may be identified by an e-mail address, although other suitable identification information may also, or alternatively, be used in document forwarding operations. In certain embodiments, a third-party e-mail application executing on a client system may be used to forward a document. In other embodiments, document forwarding may be handled using a forwarding menu associated with interface 300.

In some embodiments, rather than e-mailing or otherwise distributing sensitive documents, a link or other pointer or reference to a document can be distributed. When a recipient attempts to follow the link to access the document, appropriate controls can be enforced to ensure desired restrictions on distribution are followed.

In certain embodiments, workspace participants may forward documents to third-party users that are not participants in the workspace. Such a third-party user may receive a notification (e.g., an e-mail) with a link to the forwarded document. The third-party user may be required to complete a registration process before accessing the link and/or the document. In certain embodiments, the third-party user may be presented with a restricted version of the document. For example, the third-party user may be presented with a read-only copy of the document, a copy of the document that may not be distributed, a preview of the document (e.g., a preview of a portion of the document), and/or the like. If authorized by the workspace participant who forwarded the document, the third-party user may be able to access (e.g., download) an unrestricted copy of the original document and/or forward the document to others. In certain embodiments, the actions of third-party user may be tracked and/or audited. Based on such tracking and/or auditing, workspace participants (e.g., a document creator) may receive notifications when various actions on the document (e.g., forwarding, printing, etc.) are performed by the third-party user.

Document Usage Tracking and Auditing

In certain embodiments, various user actions relating to a workspace may be tracked and/or audited. For example, user actions including adding documents, updating documents, and/or deleting documents associated with a workspace may be tracked. Further, comments associated with user actions and/or prior document versions may be archived. User actions on documents in a workspace may also be tracked and/or audited. For example, user actions including viewing, printing, forwarding, editing, and/or other document-related actions may be tracked. Other various usage statistics relating to a document and/or a workspace may also be tracked and/or audited.

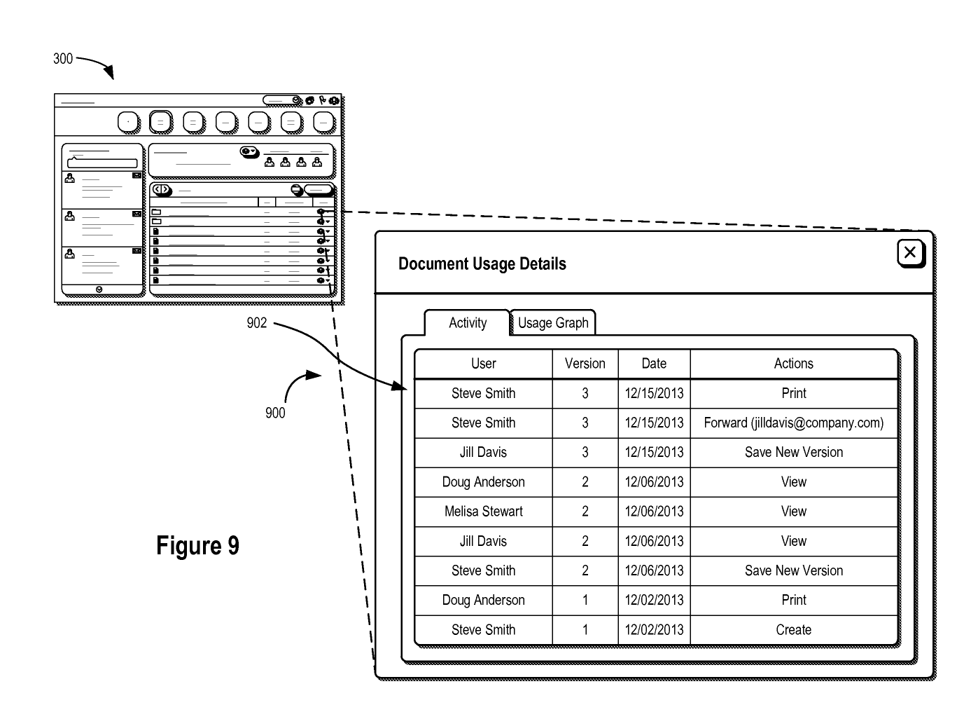

In some embodiments, to retrieve information regarding document usage, a user may select a document and provide an indication that they wish to view usage information for the document (e.g., by selecting a usage information menu option or the like). In certain embodiments, a user may be provided a document usage menu showing usage information for the document. FIG. 9 illustrates document usage menu 900 of an exemplary interface 300 for interacting with a collaboration system consistent with embodiments of the present disclosure. As illustrated, a user may be presented with a history 902 of tracked actions performed by workspace participants on the document, the dates the actions were taken, and the participants who executed the actions. Document version information may also be presented in the history 902. Tracked actions may include, without limitation, actions relating to document modifications (e.g., edit, save new version, create, etc.), actions relating to printing of the document, actions relating to forwarding the document, including, e.g., an indication as to whom a document was forwarded, and/or any other suitable information relating to the usage of the document.

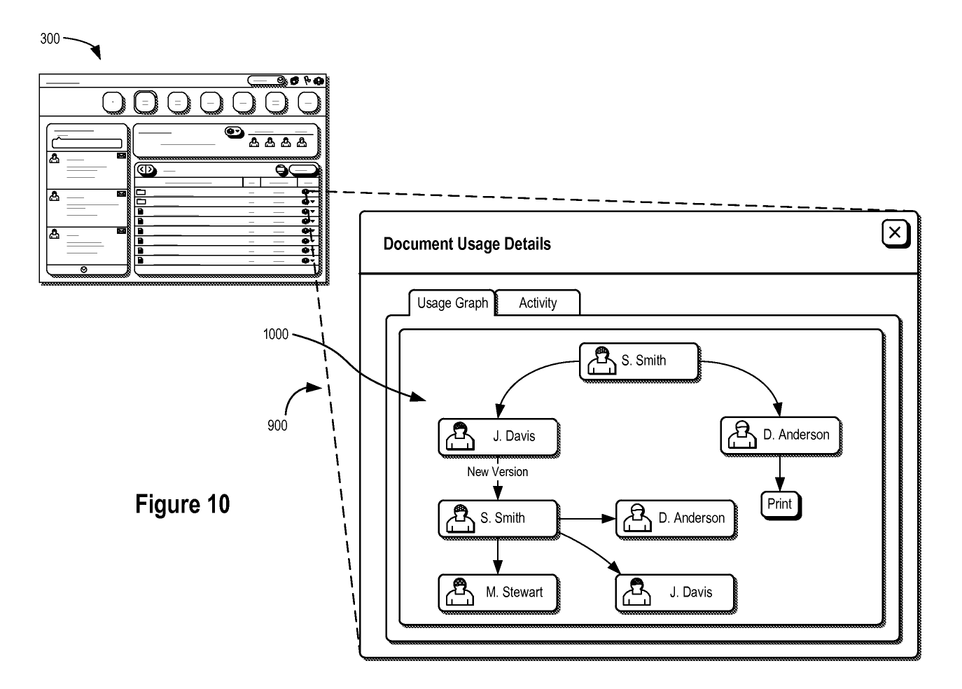

FIG. 10 illustrates another document usage menu 900 of an exemplary interface 3000 for interacting with a collaboration system consistent with embodiments of the present disclosure. In certain embodiments, document usage information may be provided to a user in a visual graph 1000. For example, as illustrated, a directed node-link graph 1000 may be generate illustrating how a document is forwarded and/or used by workspace participants. Using the graph 1000, a user may be able to determine, among other things, what actions have been performed on the document (e.g., viewed, printed, forwarded, etc.) and by whom. Selecting a node on the graph may provide information regarding, among other things, actions performed on a document by a user associated with the node, applied usage rules, attributes relating to an associated user, and/or any other suitable information. Selecting a link on the graph may provide information regarding, among other things, a date or mechanism of how the document was forwarded (e.g., e-mail, instant message, etc.).

Document Following and Notifications

A user may wish to follow a document included in a workspace. In some embodiments, any participant in a workspace can opt into follow notifications for any document within the workspace. In further embodiments, when a user adds a document to a workspace, they will by default follow the document. Changes to the document (e.g., location, name, contents, and version) may generate a notification provided to the user notifying them of the change. If a user wishes to no longer follow a document, the user may change a notification setting associated with the document removing notifications for the document.

Illustrative activities that may trigger a notification may include, without limitation, some or all of the following:
Changes to a document name or contents.
Deletion of a document.
Updating of a document.
Following of a document created by another user.
@mentioning a user in an activity stream.

Activity Streams

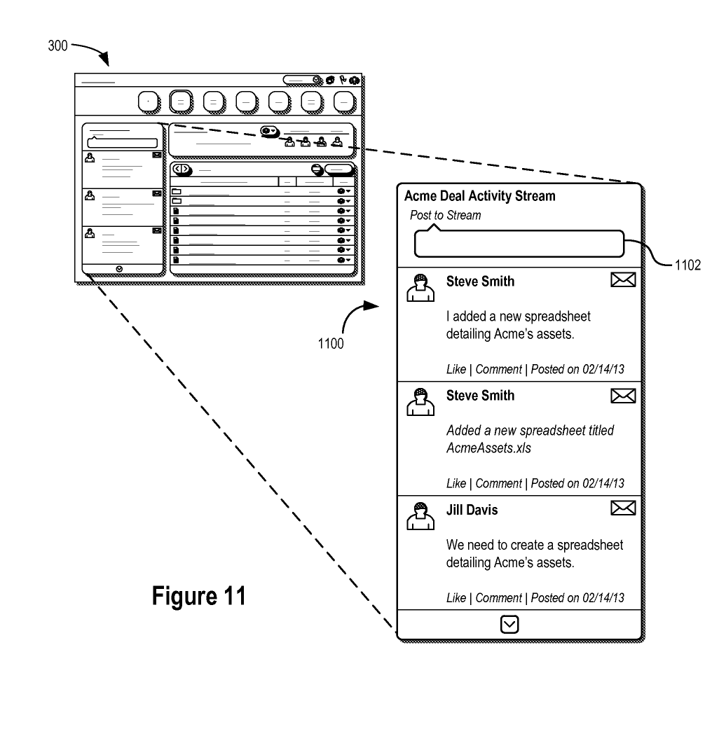

FIG. 11 illustrates an activity stream 1100 of an exemplary interface 300 for interacting with a collaboration system consistent with embodiments of the present disclosure. In certain embodiments, workspaces may include an activity stream 1110 displaying comments and updates associated with users and/or documents that are part of the workspace. The activity stream 1100 may include, among other things, active and passive updates relating to the workspace. In some embodiments, updates to an activity stream may include, without limitation, some or all of the following:
User-posted comments.
Users “liking” a post and/or a comment.
Updates regarding users and/or document activity in a workspace (e.g., updates regarding users following a document, viewing a document, printing a document, creating and/or deleting a document, etc.).
Workspace participant status (e.g., updates regarding new users to a workspace and/or the like).
Any other updates relating to a workspace, documents included in the workspace, and/or participants of the workspace.

In some embodiments, different types of updates may be displayed differently within the activity stream 1100. For example, a passive update, such as a document update, may be displayed differently than an active update, such as a user comment. In certain embodiments, different types of updates may be displayed using different colors, fonts, backgrounds, and/or any other suitable means of differentiating update types.

The activity stream 1100 may include @mention functionality, where the @ symbol and/or another suitable symbol followed by an identification of a user (e.g., name, e-mail address, username, etc.), will be converted to a link (e.g., a hyperlink) to the user's profile. In certain embodiments, when a user is @mentioned, they may receive a notification (e.g., via e-mail or an in-application notification). Similarly, users may have the ability to @mention any document within the workspace. In certain embodiments, this may generate a link to a view of the document and/or send a notification to users following the document.

Share Box

In some embodiments, a share box 1102 may be included in an activity stream 1100. In some embodiments, the share box 1102 may be an input form field appearing in the activity stream 1100 that allows users to publish comments to the activity stream 1100. In certain embodiments, the share box 1102 may be a text entry field. In further embodiments, using the share box 1102, a user may be able to attach a document, attach a link (e.g., a link to a document), and/or publish a comment entered in the share box 1102. Comments posted to the activity stream 1100 may be viewable to all participants in workspace. In yet further embodiments, a user may specify that a comment posted to the activity stream 1100 should be viewable only by a sub-set of designated workspace participants.

Hash Tags

In some embodiments, the # symbol (i.e., a hash tag) or another suitable symbol may be used to mark keywords and/or topics in a comment or post that appears in the activity stream 1100. When a user types the # symbol followed by a word, a hash tag may be generated. Clicking on a tagged word will filter the activity stream 1100 to display other comments including the tagged word. In some embodiments, any user, in any workspace, can create hash tags in any suitable manner.

Comment ‘Likes’

In some embodiments, comments posted to an activity stream 1100 may support “like” functionality. For example, as illustrated, a like button may be displayed in connection with a comment posted to the activity stream 1100. Other participants may utilize the like button to indicate their support of the comment. In certain embodiments, comments with no likes may display an indication in connection with the like button indicating that a user may be the first to like the comment. In some embodiments, a tally of users who have liked a comment may be displayed. In further embodiments, a list and/or other indication of users who have liked a comment may be displayed.

Object Referencing and Following

A variety of objects may be used in connection with the disclosed systems and methods including, for example, workspace and/or collaboration objects, file objects, folder objects, document objects, user and/or user profile objects, comment objects, task objects, external link objects, and/or the like. In certain embodiments, various objects may be referenced in connection with social communication aspects of the disclosed embodiments using @mention functionality, where the @symbol and/or another suitable symbol followed by an identification of a particular logical object may be converted to a link (e.g., a hyperlink) to information associated with the object.

As an example, in connection with posting a comment in a workspace activity stream 1100, a user may reference a particular workspace by @mentioning the workspace. The posted comment may include a link to the @mentioned workspace. Upon selecting (e.g., clicking) the link, a user may be directed to a workspace menu associated with the @mentioned workspace. In further embodiments, upon selecting the link, a user may be presented with information regarding the workspace (e.g., an overview and/or other description of the workspace) without being directed to an associated workspace menu (e.g., via a floating text box, pop-up window, and/or the like).

In certain embodiments, a user may wish to follow an object and/or receive notifications regarding activities associated with an object. In some embodiments, any participant in a workspace can opt into following notifications for objects within the workspace. In certain embodiments, object following may be governed by certain rights and/or permissions. That is, a user may only be able to follow objects that the user has certain rights, permissions, and/or the link to follow (e.g., rights and/or permissions to follow an object, access an object, view an object, edit an object, and/or the like). Changes to an object (e.g., updates to a document or workspace name, changes to a task status, etc.) and/or activity performing using the object by the user and/or other users may generate a notification provided to the user following the object (e.g., a notification of a change or the like). If a user wishes to no longer follow an object, the user may change a notification setting associated with the object

In-Application Notifications

In certain embodiments, in-application notifications may provide short descriptions regarding updates that pertain to a specific user. When the user selects a specific update, they may be directed to a file, comment, and/or workspace that requires their attention. In some embodiments, a variety of actions may trigger in-application notifications including, for example, some or all of the following:
A user being @mentioned in an activity stream comment.
A user being invited to join a workspace.
A user receiving a response to a posted comment.
A user receiving a “like” on a posted comment.
A document created or followed by a user has been edited or otherwise changed (e.g., renamed, deleted, etc.).
A sent invitation is accepted.

Any activity of an @mentioned object a user has indicated an interest in following.

It will be appreciated that a wide variety of other actions could be configured trigger in-application notifications.

Workspace and Document Analytics Services

In certain embodiments, a variety of analytics may be provided to a user relating to the workspace and/or documents included in the workspace. For example, in some embodiments, a user may be provided an indication of status regarding a document's popularity (e.g., a number of accesses), user activity, and/or the like. For example, in some embodiments one or more of the following exemplary statistics relating to a workspace and/or documents included therein may be provided to a user:
Outstanding tasks.
Trending documents.
Outstanding user invites.
Popular documents.
Active participants.
New participants.
Recent activity.
Suggested workspaces (e.g., based on usage pattern analysis or the like).

It will be appreciated that a variety of other statistics relating to a workspace and/or its documents may be provided. In certain embodiments, an enterprise may use workspace and document analytics services to manage workspaces and/or documents associated with the enterprise. For example, an enterprise may identify seldom-used documents that could be deleted and/or archived.

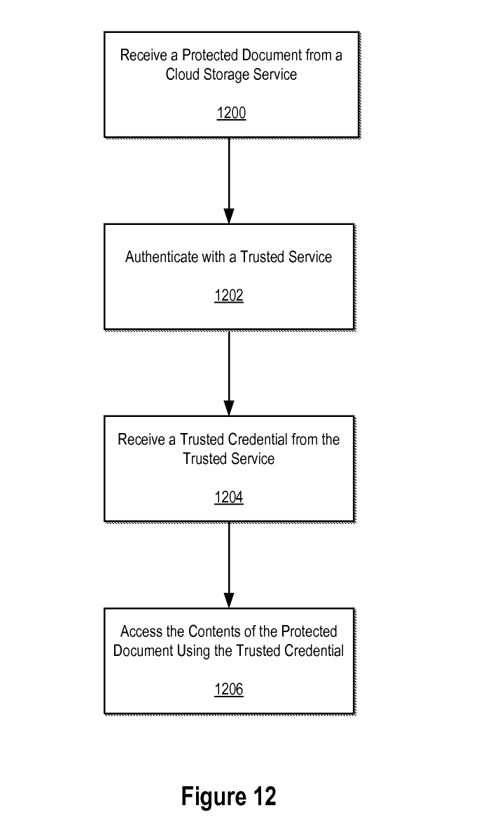

FIG. 12 illustrates a flow chart of an exemplary method of accessing a document stored by a cloud storage system consistent with embodiments of the present disclosure. In certain embodiments, the method may be utilized by a client system in accessing a protected document stored by a cloud storage system. The client system may receive a protected document from the cloud storage system 1200. In certain embodiments, the protected document may be protected through encryption utilizing one or more cryptographic keys.

The client system may authenticate itself with a trusted system 1202. In certain embodiments, the authentication may involve the client system providing the trusted system with one or more credentials indicating that the client system is authorized to access the protected document. In further embodiments, the authentication may involve the trusted system verifying that the client system possesses certain secure software and/or hardware.

After the client system is authenticated, the trusted system may distribute a cryptographic key or other trusted credential to the client system 1204. The cryptographic key or trusted credential may be utilized by the client system to access (e.g., decrypt) the protected document 1206. By offering trusted cryptographic services independent from the cloud storage system and not disclosing trusted credentials and/or cryptographic keys to the cloud storage system, risks associated with storing enterprise data in the cloud may be mitigated.

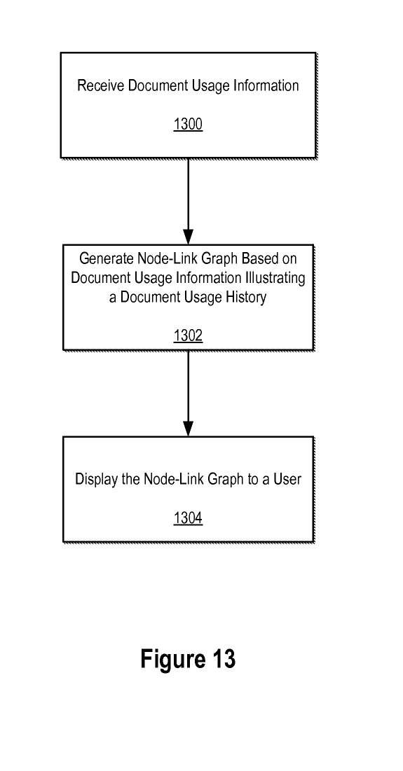

FIG. 13 illustrates a flow chart of an exemplary method of generating a document activity graph consistent with embodiments of the present disclosure. In certain embodiments, the method may be utilized by a client system to provide one or more visualizations allowing a user to view and/or understand how documents are distributed and used by others in a workspace. In certain embodiments, the client system may receive document usage information relating to the usage of a document 1300. Using the document usage information, the client system may generate 1302 and display 1304 a visual graph illustrating how a document is forwarded and/or used by participants in a workspace. In certain embodiments, the graph may be a node-link graph. Using the graph, a user of the client system may be able to determine, among other things, what actions have been performed on the document (e.g., viewed, printed, forwarded, etc.) and by whom. Selecting a node on the graph may provide information regarding, among other things, actions performed on a document by a user associated with the node, applied usage rules, attributes relating to an associated user, and/or any other suitable information. Selecting a link on the graph may provide information regarding, among other things, a date or mechanism of how the document was forwarded (e.g., e-mail, instant message, etc.).

Task Management

Systems and methods disclosed herein may further facilitate task management in connection with secure, governed, and/or audited collaboration and/or document management services. In certain embodiments, task management functionality may be integrated with social collaboration and/or communication features. In some embodiments, task management functionality may be integrated with social collaboration and/or communication services in connection with a single interface (e.g., in connection with an activity stream and/or the like). For example, various activities performed in connection with tasks may be tracked and/or otherwise audited and displayed in connection with social communication features of a collaboration service (e.g., via activity streams or the like). Integration of certain social communication and task management features into a single activity stream or interface may, among other things, facilitate more efficient project organization and coordination.

A variety of activities may be performed by a user using task management features of a collaboration system consistent with embodiments disclosed herein. For example, a user may create a task and/or provide various information regarding a task including, without limitation, a title of the task, a description of the task, a collaboration participant or participants assigned to the task, a completion date for the task, a priority for the task, and/or the like. A user may further view and/or manage existing tasks and associated information, upload and/or otherwise associate documents with a task (e.g., using @mentioning or the like), track the progress of a task, change a status of a task (e.g., change a pending, completed, and/or other status associated with a task), and/or the like. It will be appreciated that there are a variety of activities that may be performed by a user in connection with managing tasks, and that the disclosed systems and methods may be utilized in connection with and/or otherwise facilitate any suitable task management activity.

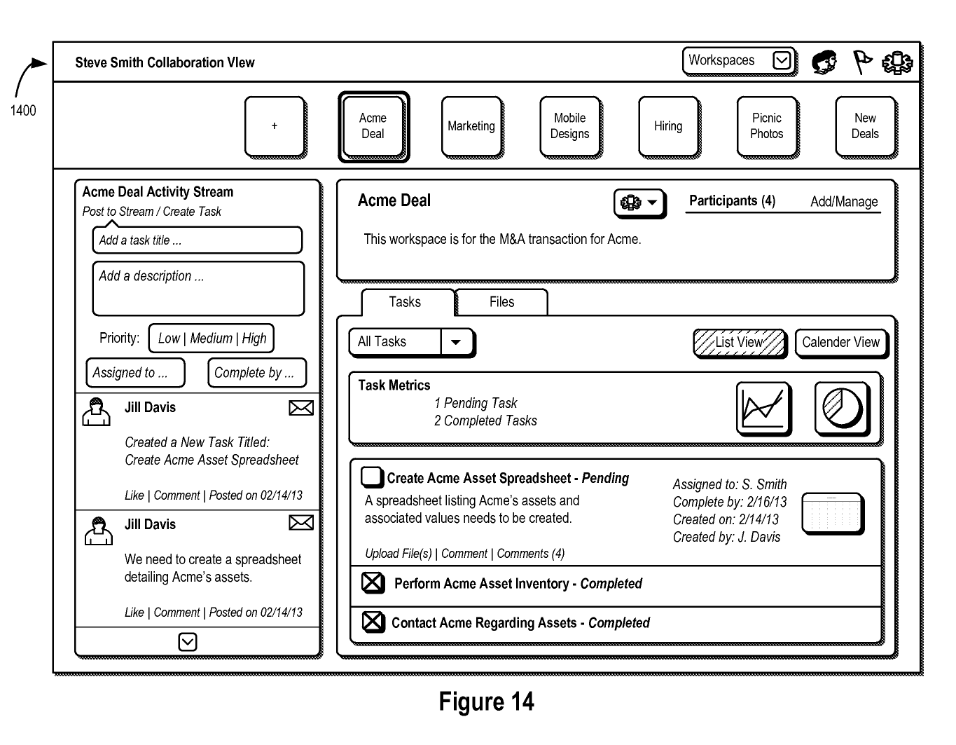

FIG. 14 illustrates an exemplary interface 1400 for interacting with task management functionality of a collaboration system consistent with embodiments of the present disclosure. In certain embodiments, the interface 1400 may be similar to the interface illustrated in and described above in reference to FIG. 3. For example, in some embodiments, certain aspects of the interface 1400 may be accessed as a sub-interface, menu, and/or console of the interface illustrated in and described in reference to FIG. 3 (e.g., by selecting a task management view selection or the like).

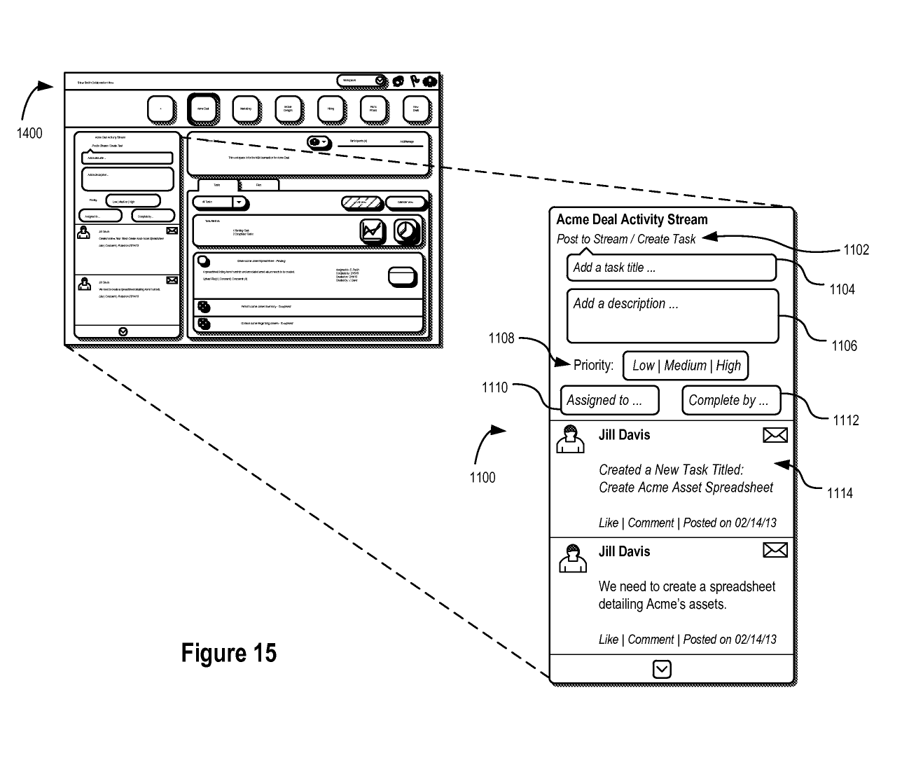

In certain embodiments, the exemplary interface 1400 may be associated with a cloud storage service provider and/or a trusted collaboration service as described herein. In further embodiments, the exemplary interface 1400 may be an interface of an application executing on a client system interacting with a cloud storage service provider and/or a trusted collaboration service. In certain embodiments, the interface 1400 may be an HTML5-based interface displayed, for example, in a web-browser application. In further embodiments, the interface 1400 may be a mobile device interface, a computer system application interface (e.g., a desktop application interface), an interface of a plugin for one or more third-party applications (e.g., an email program, word processing program, office suite of programs, etc.), and/or any other type of interface. In some embodiments, the interface 1400 may mirror and/or be an interface of a third-party cloud storage service provider while, in other embodiments, the interface 1400 may be a uniform interface across third-party cloud storage service providers. Certain elements of the exemplary interface 1400 are illustrated and described in more detail below in reference to FIGS. 15-18.

FIG. 15 illustrates task management in connection with an activity stream 1100 of an exemplary interface 1400 for interacting with a collaboration system consistent with embodiments of the present disclosure. The activity stream 1100 illustrated in connection with exemplary interface 1400 may include any of the activity stream features described herein (e.g., described in reference to and/or illustrated in FIG. 11).

In certain embodiments, task creation functionality may be integrated into an activity stream 1110. A user may initiate task creation using a create task and/or similar button 1102 included in the activity stream 1100. Upon selecting the button 1102, a task title box 1104 and/or a task description box 1106 may be displayed in the activity stream 1100. In some embodiments, selecting the button 1102 will cause a share box included in the activity stream 1100 to change to certain boxes and/or buttons associated with task creation (e.g., a title box 1104, a task description box 1106, etc.). The task title box 1104 may be an input form field (e.g., a text entry field) appearing the activity stream 1100 that allows users to enter a title of a task. Similarly, the task description box 1106 may be an input form field (e.g., a text entry field) appearing the activity stream 1100 that allows users to enter a description of a task.

The activity stream 1100 may further include a task priority selection button 1108, a task assignment field 1110, and a task completion date field 1112. Using the task priority selection button 1108, users may associate a priority with a task from one or more priority types (e.g., low, medium, high, etc.). Alternatively, users may associate a task with a custom and/or user-defined priority. The task assignment field 1100 may allow a user to associate and/or otherwise assign the task with one or more users of a workspace. In certain embodiments, a user may access a contact list associated with the collaboration system in connection with assigning one or more users to a task. Although not specifically illustrated, in certain embodiments, a user may select and/or otherwise define one or more roles and/or responsibilities of one or more users assigned to a task.

The task completion date field 1112 may allow a user to associate a task with one or more completion dates. In certain embodiments, a task may be associated with a plurality of completion dates (e.g., dates associated with different phases of a task). In further embodiments, a task may be associated with a single completion date. In some embodiments, a user may access a calendar (e.g., a pop-up calendar or the like) in connection with entering a task completion date using the task completion date field 1112. Although not specifically illustrated, a user may further be able to upload and/or otherwise associate documents and/or files (e.g., using @mentioning or the like), attach a link, and/or associate a comment with a new task.

After entering relevant task information, a user may create an associated task. In certain embodiments, users assigned to the task may receive a notification when the task is created. In further embodiments, an indication of activities pertaining to tasks in a workspace may be included in an activity stream 1100 displaying comments, updates, and/or other activities associated with users, documents, tasks, and/or other objects that are part of the workspace. For example, as illustrated, an indication 1114 of a new task being created may be posted to an activity stream 1100 of an associated workspace. A variety of other task-related updates may be posted to the activity stream 1100, including changes to task participants (e.g., assigned users), task title and/or description information, task status (e.g., pending, completed, etc.), and/or the like.

In some embodiments, task-related updates to the activity stream 1100 may include, without limitation, some or all of the following:
Changes to task information including, for example, changes to task participants (e.g., assigned users), changes to task titles and/or descriptions, changes to a status associated with a task and/or constituent phases (e.g., pending, completed, awaiting response, etc.), changes to task completion date(s), and/or the like.
User-posted comments relating to tasks (e.g., comments @mentioning a task, etc.)
Updates regarding user activities relating to tasks (e.g., updates regarding users following a task, task viewing information, etc.).
Any other updates relating to tasks, workspaces, users, documents, and/or participants of the workspace.

Task-related information posted to the activity stream 1100 may be viewable to all participants in workspace. In further embodiments, a user creating a task and/or another authorized party may specify that associated information posted to the activity stream 1100 should be viewable only by a sub-set of designated workspace participants and/or users associated with a task (e.g., users assigned to the task and/or the like).

In some embodiments, different types of updates may be displayed differently within the activity stream 1100. For example, a passive update, such as an indication of a task being initially created, may be displayed differently than an active update, such as a user comment posted in connection with a task. In certain embodiments, different types of updates may be displayed using different colors, fonts, backgrounds, and/or any other suitable means of differentiating update types.

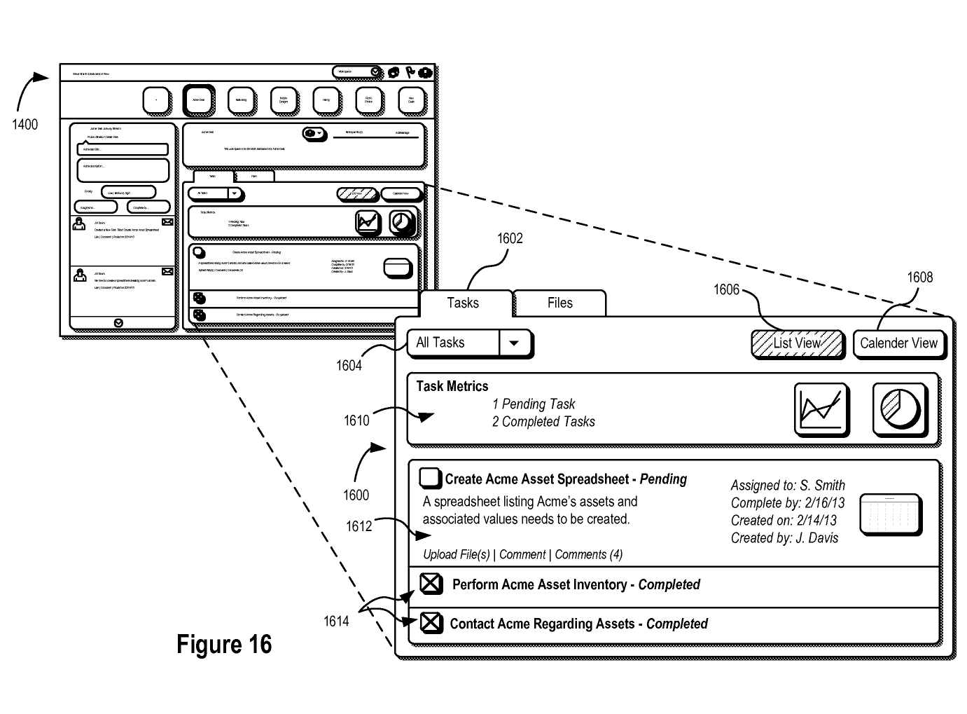

FIG. 16 illustrates an exemplary task navigation menu 1600 of an exemplary interface 1400 for interacting with a collaboration system consistent with embodiments of the present disclosure. The task navigation menu 1600 may provide various task management functionalities. In certain embodiments, the task navigation menu 1600 may display various tasks associated with a workspace and allow users to browse and/or otherwise manage the tasks and/or information associated therewith

The task navigation menu 1600 may opened in the interface 1400 in a variety of ways. For example, in some embodiments, a user may select an appropriate button 1602 toggling between the document navigation menu described above and illustrated in connection with FIG. 8 and the task navigation menu 1600. In alternative embodiments, the task navigation menu 1600, the document navigation menu, and/or portions thereof may be simultaneously viewed via the interface 1400.

Tasks displayed in the task navigation menu 1600 may include both active/pending tasks 1612 and/or completed tasks 1614. In certain embodiments, tasks displayed in the task navigation menu 1600 may be filtered according to status using a task filter menu 1604. For example, using the task filter menu 1604, a user may display all tasks (e.g., as illustrated in FIG. 16), pending tasks, completed tasks, in progress-tasks, and/or the like. In further embodiments, a user may filter tasks based on a variety of other parameters. For example, tasks may be filtered based on a task creator, names of users to which tasks have been assigned, task creation and/or last update dates, task progress, and/or any other parameter associated with a task a user may wish to use in connection with filtering tasks displayed in the task navigation menu 1600.

Tasks may be displayed in the task navigation menu 1600 in a variety of ways. For example, as illustrated, tasks may be displayed in a list (e.g., selected by a user using a list view button 1606 or the like). The list may be organized in a variety of ways including, without limitation, based on task creation date, task completion date, task name, task creator, task priority, task status, and/or the like. For example, as illustrated, active/pending tasks 1612 may be displayed at a top of the list, and completed tasks 1614 may be displayed following the active/pending tasks 1612. In further embodiments, task may be displayed in a calendar view (e.g., selected by a user using a calendar view button 1608 or the like). For example, task information may be displayed in a calendar view based on task completion dates, creation dates, status update dates, and/or the like.

Different participants in a workspace may be shown different tasks in the task navigation menu 1600 based on their assigned roles. For example, workspace participants who are not assigned to a task may not see the task in the task navigation menu 1600. In certain embodiments, a participants' role in relation to a task may be displayed in the task navigation menu 1600 (e.g., task creator, task assignee, etc.).

Various task metrics 1610 may be displayed in connection with the task navigation menu 1600. Displayed task metrics 1610 may include various metrics, analytics, and/or other information associated with and/or derived from tasks associated with a workspace. In certain embodiments, displayed task metrics 1610 may include various types of numerical information relating to tasks (e.g., a number of active/pending tasks, completed tasks, tasks assigned by a particular user, average number of days to complete tasks, number of tasks having completion dates falling within a particular period, etc.). Displayed task metrics 1610 may further include graphical information relating to tasks (e.g., graphs derived from numerical information relating to tasks and/or the like).

A variety of information may be displayed in connection with tasks 1612, 1614 included in the task navigation menu 1600. For example, in some embodiments, information regarding a task title, status, description, creation date, completion date, creator, assignees, and/or any other information associated with a task may be displayed in the task navigation menu 1600. In certain embodiments, information included in the task navigation menu 1600 may be an overview of information associated with the task.

In certain embodiments, a user may be able to interact with a task via the task navigation menu 1600 in a variety of ways. For example, a user may be able to generate and associate comments with a task, view comments associated with a task, upload and/or otherwise associate a document with a task, and/or the like. In addition, a user may be able to make certain changes and/or updates to a task from the task navigation menu 1600. For example, a user may, among other things, update and/or otherwise change a status associated with a task (e.g., change a status of task from pending to complete).

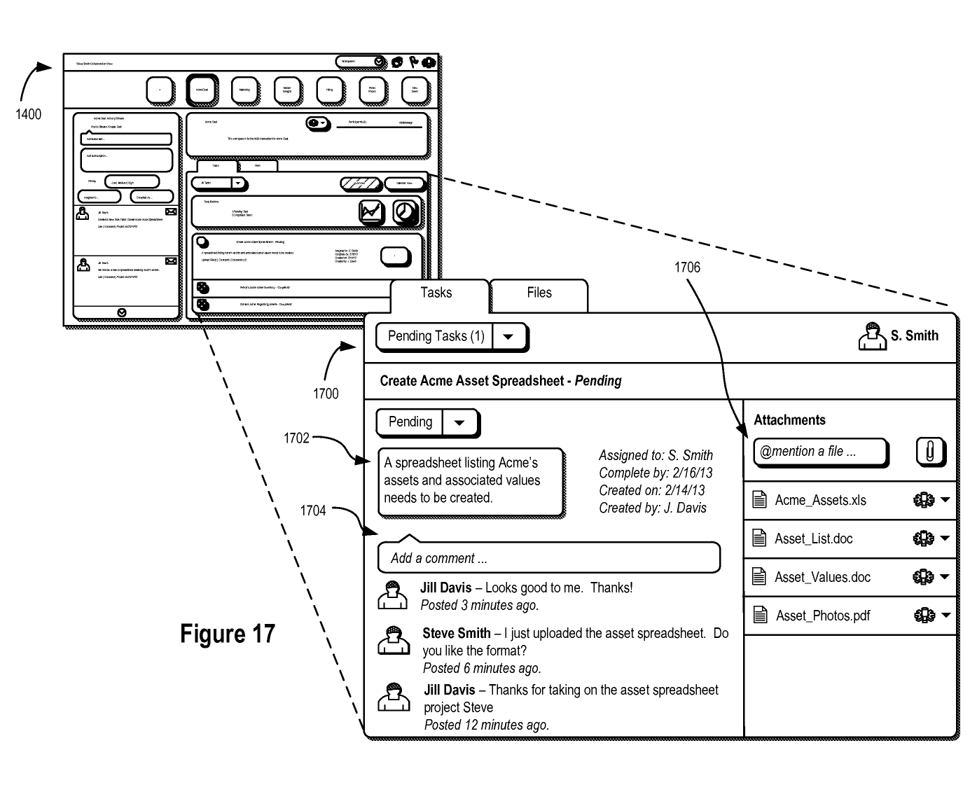

FIG. 17 illustrates an exemplary task panel 1700 of an exemplary interface 1400 for interacting with a collaboration system consistent with embodiments of the present disclosure. The task panel 1700 may provide various task management functionalities and/or may display information associated with a particular task. In certain embodiments, a task panel 1700 for a particular task may be accessed by selecting a particular task from a task navigation menu (e.g., a task navigation menu incorporating elements described in reference to and/or illustrated in connection with FIG. 16).

In certain embodiments, task information 1702 regarding a task including, for example, a task title, status, description, creation data, completion date, creator, assignees, and/or any other information may be displayed in the task panel 1700. In certain embodiments, such task information 1702 may be changed and/or otherwise updated if a user has appropriate rights and/or permissions to make such changes. As an example, a task creator may be allowed to change a task title, description, task assignees, and/or targeted completion date within a task panel 1700, whereas a task assignee may be unable to change such information.

Certain social communication features of a collaboration system associated with interface 1400 may be displayed in connection with the task panel 1700. For example, as illustrated, a task-specific activity stream 1704 may be displayed in the task panel 1700. In some embodiments, the task-specific activity stream 1704 may include an associated share box (e.g., an input form field such as a text entry field allowing users to publish comments and/or other information to the task-specific activity stream 1704). In further embodiments, the share box may allow a user to attach and/or otherwise reference a document (e.g., using @mentioning or the like) and associate it with a particular task displayed in the task panel 1700.

The task-specific activity stream 1704 may include updates and/or other information related to a particular task displayed in the task panel 1700. In certain embodiments, task-related updates to the task-specific activity stream 1704 may include, without limitation, some or all of the following:
Changes to task information regarding a particular task displayed in the task panel 1700 including, for example, changes to task participants (e.g., assigned users), changes to task titles and/or descriptions, changes to a status associated with a task and/or constituent phases (e.g., pending, completed, awaiting response, etc.), changes to task completion date(s), and/or the like.
User-posted comments relating to a task displayed in the task panel 1700 (e.g., comments @mentioning the task, etc.)
Updates regarding user activities relating to a task displayed in the task panel 1700 (e.g., updates regarding users following a task, task viewing information, etc.).

Integration of social communication features of a task-specific activity stream 1704 and other task management features into the task panel 1700 may, among other things, facilitate more efficient project organization and coordination when compared to conventional systems in which social communication and task management features may be handled by separate products and/or in separate silos. Moreover, integration of a task-specific activity stream 1704 into the task panel 1700 may enable a user to more quickly ascertain a variety of information regarding a displayed task including, for example, status of the task and/or a history activities performed relating to the task. Comments posted to the task-specific activity stream 1704 may be viewable to all participants in a workspace. In yet further embodiments, a user may specify that a comment posted to the task-specific activity stream 1704 should be viewable only by a sub-set of designated workspace participants (e.g., task creators, task assignees, and/or the like).

Documents associated with a particular task displayed in the task panel 1700 may be displayed in a task-specific document menu 1706. In certain embodiments, the task-specific document menu 1706 may incorporate certain features of the document navigation menu described above in reference to FIG. 8. The task-specific document menu 1706 may provide various file and/or document management functionalities associated with a particular task displayed in the task panel 1700. In certain embodiments, the task-specific document menu 1706 may display files and/or documents associated with a particular task displayed in the task panel 1700. In further embodiments, the task-specific document menu 1706 may further display folders associated with a particular task displayed in the task panel 1700 and allow users to browse and/or otherwise manage the folders and/or documents and files included therein.

In some embodiments, the task-specific document menu 1706 may, for example, provide, without limitation, some or all of the following functions:
View toggling (e.g., toggling between thumbnail views, list views, path views, and/or the like).
Nested folders.
Drag and drop interaction (e.g., from a desktop or the like).
New folder creation.
File and/or folder uploading
File and/or folder references (e.g., using @mention functionality and/or the like)
File and/or folder deletion.
File and/or folder renaming.
Cut, copy, and/or paste operations.
File moving operations.
Document settings management including, for example, management of rules and/or rights associated with a document.
File storage and search using document content and/or metadata information including, without limitation, file name, extension, date modified, size, last edit date, file type, last opened data, last user to open or update, and/or the like.
Searching operations.

Different participants in a workspace may be shown different files and/or folders in the task-specific document menu 1706 based on their assigned roles. For example, users who are not assigned to a task and/or are a task creator may not see documents and/or folders associated with the task in the task-specific document menu 1706. As discussed above, a user's rights to view and/or otherwise interact with a document, file, and/or folder may further depend on the user's rights and/or role relative to the particular document.

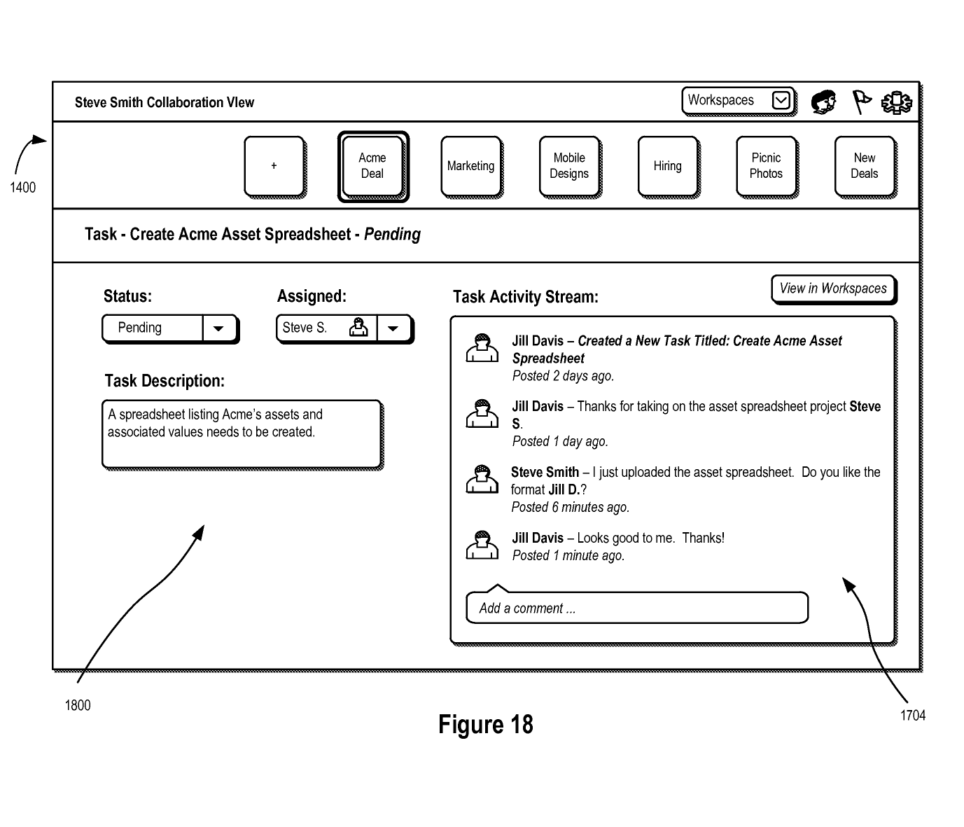

FIG. 18 illustrates an exemplary task creation menu 1800 of an exemplary interface 1400 for interacting with a collaboration system consistent with embodiments of the present disclosure. As discussed above in reference to FIG. 15, in certain embodiments, task creation functionality may be integrated into an activity stream associated with a workspace. In alternative embodiments, a task creation menu 1800 separate from a workspace activity stream 1400 may be utilized. Using the task creation menu 1800 a user may perform, without limitation, some or all of the exemplary following functions:
Create a task title and/or description.
Assign a task to one or more participants in a workspace.
Assign a status to a task and/or one or more constituent phases of a task (e.g., pending, active, completed, etc.).
Assign one or more completion dates to a task.
Upload and/or otherwise associate documents with a task (e.g., using @mentioning functionality and/or the like).
Update an existing task (e.g., update a task description, reassign the task to other workspace participants, change a completion date, update a task status, etc.).

Although discussed in connection with task creation activities, the task creation menu 1800 may further be utilized in connection with managing, updating, and/or viewing information associated with a particular task after the task has been created. In certain embodiments, a task-specific activity stream 1704 may be included in the task creation menu 1800 and include updates and/or other information related to a particular task displayed in the task creation menu 1800. Task-related updates to the task-specific activity stream 1704 may include, without limitation, some or all of the types of updates described herein. In addition, in some embodiments, tasks and/or associated information used in connection with the disclosed embodiments may be exported and/or otherwise transmitted to third-party application and/or services (e.g., calendaring applications or the like).

Mobile Integration

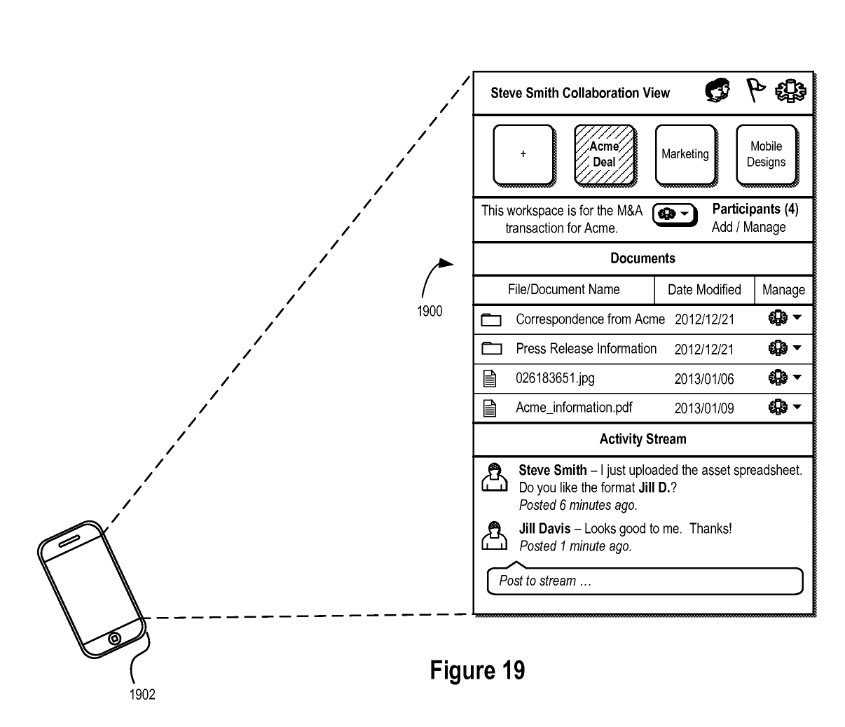

FIG. 19 illustrates an exemplary mobile interface 1900 for interacting with a collaboration and/or document management system consistent with embodiments of the present disclosure. Embodiments disclosed herein may provide for secure, governed, and/or audited collaboration and/or document management services in connection a mobile device 1902. Although illustrated as a smartphone device, it will be appreciated that the mobile device 1902 may comprise any mobile device suitable to implement embodiments of the disclosed systems and methods (e.g., a tablet computing device or the like)

In certain embodiments, a mobile interface 1900 for interacting with a collaboration and/or document management service using a mobile device 1902 may be optimized for the mobile device 1902. For example, the mobile interface 1900 may be optimized for display dimensions of the mobile device 1902 and/or for interaction using various user input capabilities of the device 1902 (e.g., touch screen inputs and/or the like). The mobile interface 1900 may provide a variety of interactive features associated with a collaboration and/or document management service including, without limitation, workspace, document, and/or task navigation and/or management, social communication and/or collaboration features such as an activity stream, and/or the like. It will be appreciated that any collaboration and/or document management system features disclosed herein may be included in the mobile interface 1900.

The mobile interface 1900 may be associated with a collaboration and/or document management application executing on the mobile device 1902. The mobile interface 1900 may be displayed on the mobile device 1902 when an associated application is launched on the device 1902. In certain embodiments, the application may be “locked” on the mobile device 1902 (e.g., by an enterprise administrator and/or the like). In some embodiments, “locking” the application on the mobile device 1902 may prevent a user of the device 1902 from using other device applications and/or device features not offered within the collaboration and/or document management application without authorization from an enterprise administrator. Such techniques may allow the mobile device 1902 to operate as a customized enterprise-based device offering functionality associated with embodiments of the disclosed collaboration and/or document management services. By enabling the deployment of customized enterprise devices using existing and/or available hardware platforms (e.g., smartphone devices or the like), such techniques may enable adoption and/or deployment of such devices by enterprises with relative ease and lower cost.

Desktop Integration

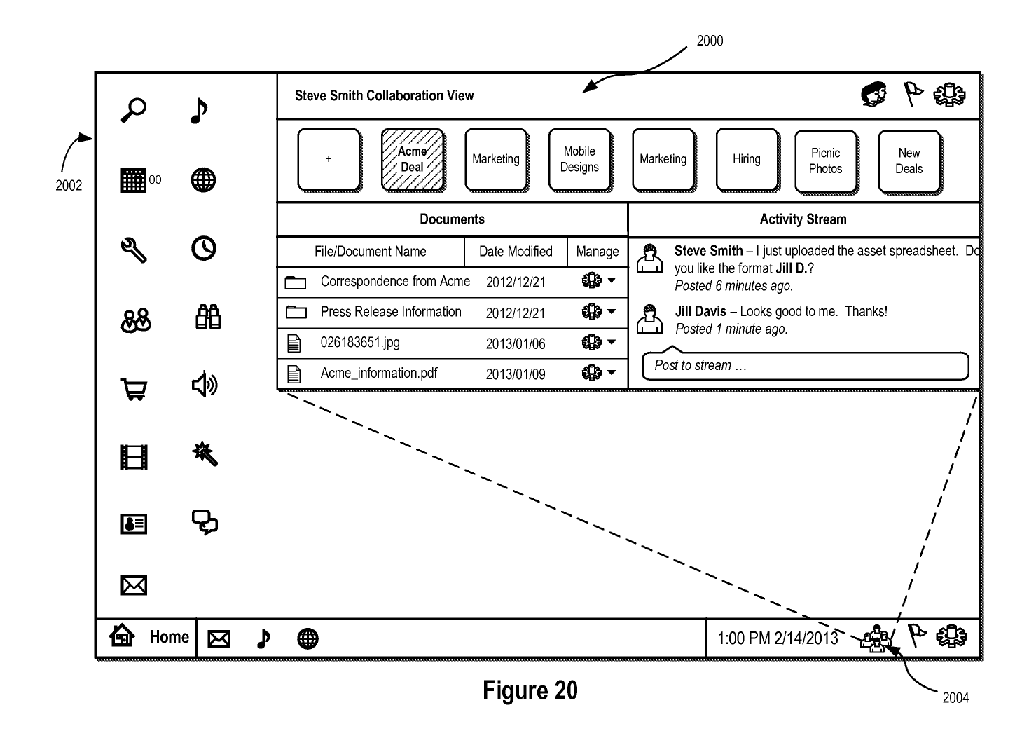

FIG. 20 illustrates an exemplary integrated desktop interface 2000 for interacting with a collaboration system consistent with embodiments of the present disclosure. The integrated desktop interface 2000 may be associated with a collaboration and/or document management application executing on an associated computer system. In certain embodiments, the interface 2000 may be an extension of a desktop interface 2002 accessed via, for example, an associated launch icon 2004 or the like. In certain embodiments, the launch icon 2004 may be fixed to a toolbar and/or other persistent component of the desktop interface 2002 (e.g., a desktop widget and/or the like).

The integrated desktop interface 2000 may allow a user to interact with the collaboration and/or document management application executing on the computer system. For example, the integrated desktop interface 2000 may provide a variety of interactive features associated with a collaboration and/or document management service including, without limitation, workspace, document, and/or task navigation and/or management, social communication and/or collaboration features such as an activity stream, and/or the like. It will be appreciated that any collaboration and/or document management system feature disclosed herein may be included in the integrated desktop interface 2000. In certain embodiments, the integrated desktop interface 2000 may facilitate more seamless interaction between features of a collaboration and/or document management service and the desktop 200 and/or other applications. For example, a user may be able to drag and drop folders, documents, and/or other files between a document navigation menu associated with the integrated desktop interface 2000 and the desktop 2002 and/or another application executing on the system (e.g., a file browsing application or the like).

Collaboration System Search and Active Search Results

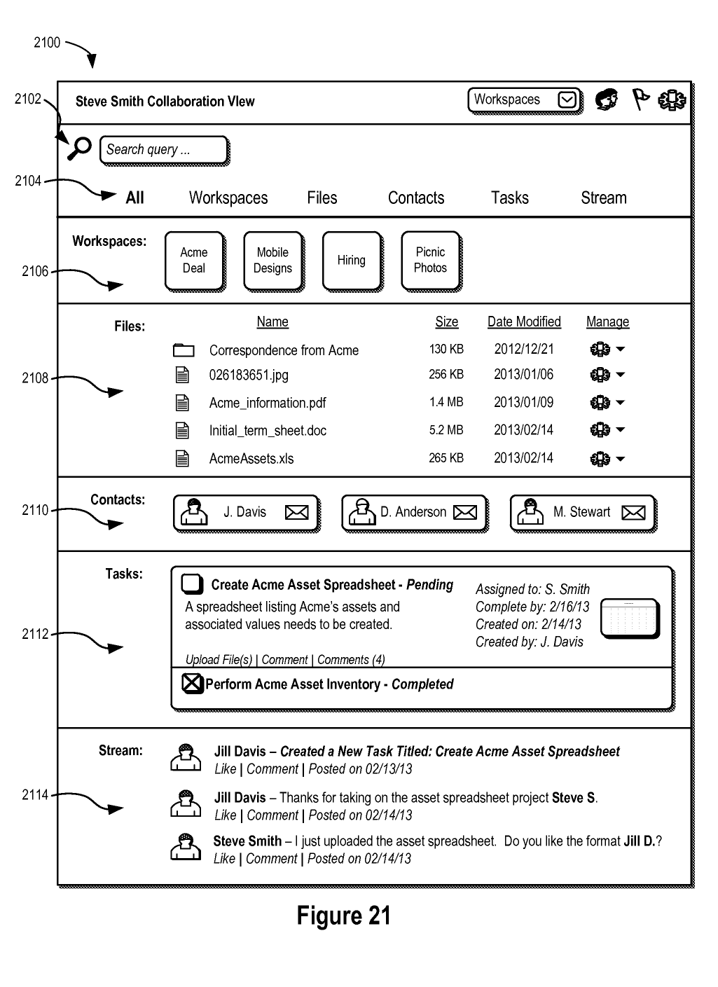

FIG. 21 illustrates an exemplary search panel 2100 for interacting with a collaboration system consistent with embodiments of the present disclosure. In certain embodiments, the search panel 2100 may be utilized to search for various information included in and/or otherwise managed by a collaboration and/or document management service. For example, as discussed in more detail above, a variety of objects may be used in connection with the disclosed systems and methods including, for example, workspace and/or collaboration objects, file objects, folder objects, document objects, user and/or user profile objects, comment objects, task objects, external link objects, and/or the like. Using the search panel 2100, a user may identify objects relevant to and/or associated with certain search criteria provided by the user.

In certain embodiments, a user may provide search criteria in a search query box 2102. In some embodiments, search criteria may be text and/or keyword based. In further embodiments, a variety of other types of search criteria and or search criteria boxes may be utilized (e.g., defined date ranges, document types, and/or the like). In certain embodiments, search results may be filtered according to object type. For example, as illustrated, a user may utilize menu selections 2104 to select a particular object type for searching (e.g., all objects, workspace objects, file objects, contact objects, task objects, activity stream objects, etc.).

Search results based on the search criteria may be displayed in the search panel 2100. For example, as illustrated, workspace search results 2106, document, file, and/or folder search results 2108, contact search results 2110, task search results 2112, and/or activity stream search results 2114 may be displayed in the search panel 2100. In certain embodiments, the search results may comprise active search results, enabling a user to interact with the results in a variety of ways. For example, with respect to document, file, and/or folder search results 2108, a user may, among other things, be able to download a document, file, and/or folder, view and/or modify permissions associated with a document, file, and/or folder, delete a document, file, and/or folder, forward a document, file, and/or folder to another user, and/or the like using the active search results presented in connection with the search panel 2100.

As an another example, a user may be able to update the status of a task identified in the task search results 2112, upload a document, file, and/or folder associated with the task, provide a comment in connection with the task, and/or view comments associated with the task from the active search results presented in connection with the search panel 2100. In yet another example, a user may be able to like and or comment on activities reflected in activity stream search results 2114 presented in connection with the search panel 2100. Providing active search results may, among other things, allow a user to interact with various features and/or aspects of the disclosed services directly from a search results page and/or a search panel 2100, thereby increasing efficiency and/or ease of use the disclosed systems and methods.

Administrator Console

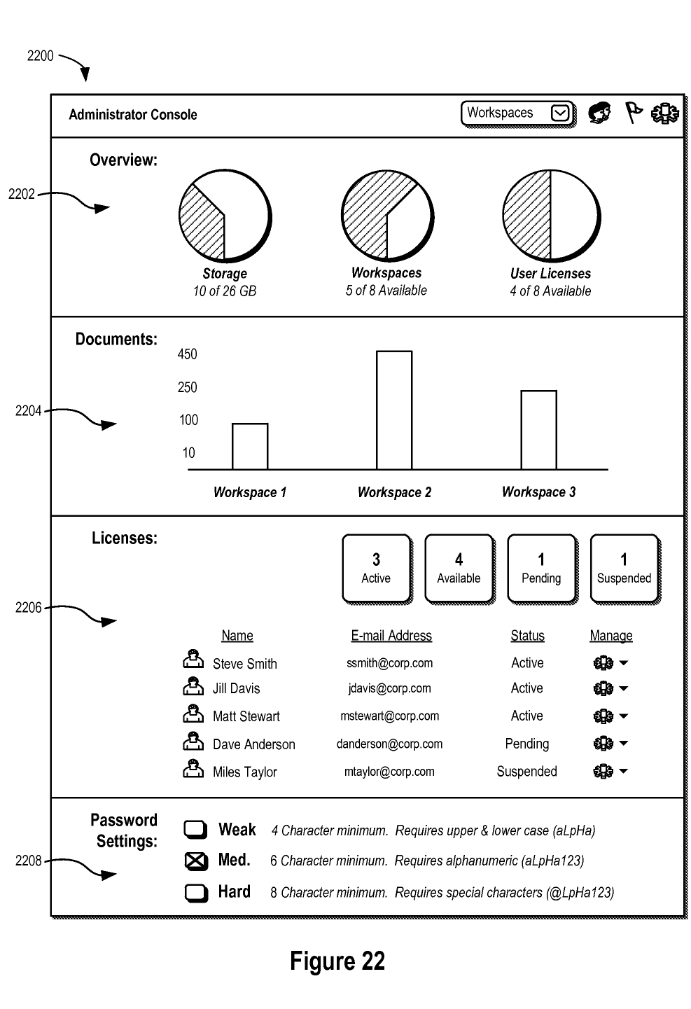

FIG. 22 illustrates an exemplary administrator console 2200 for interacting with a collaboration system consistent with embodiments of the present disclosure. In certain embodiments, the administrator console 2200 may allow for administration (e.g., centralized administration) of workspaces, collaborations, users, and/or other aspects of a collaboration and/or document management service consistent with embodiments disclosed herein. In certain embodiments, an enterprise license associated with embodiments of the collaboration and/or document management services disclosed herein may allow for a certain amount of storage and/or number of workspaces and/or users. Using the administrator console 2200, an administrator may view certain metrics 2202 associated with an enterprise license including, for example, available storage, workspaces, and/or user licenses. In further embodiments, the administrator console 2200 may provide an administrator with certain workspace-specific metrics 2204 such as, for example, a number of documents associated with workspaces associated with an enterprise license.

The administrator console 2200 may further facilitate management of user licenses associated with an enterprise license of the disclosed collaboration and/or document management service through a license menu 2206. For example, using a license menu 2206, an administrator may assign licenses to users, change license status of users (e.g., active, suspended, etc.), and/or perform any other license-related management activities consistent with embodiments disclosed herein. An administrator may perform a variety of other administrative activities using the administrator console including, for example, modifying password setting requirements 2208 and/or other aspects of the disclosed collaboration and/or document management services. It will be appreciated that a variety of other administrative activities may be performed using the administrator console 2200.

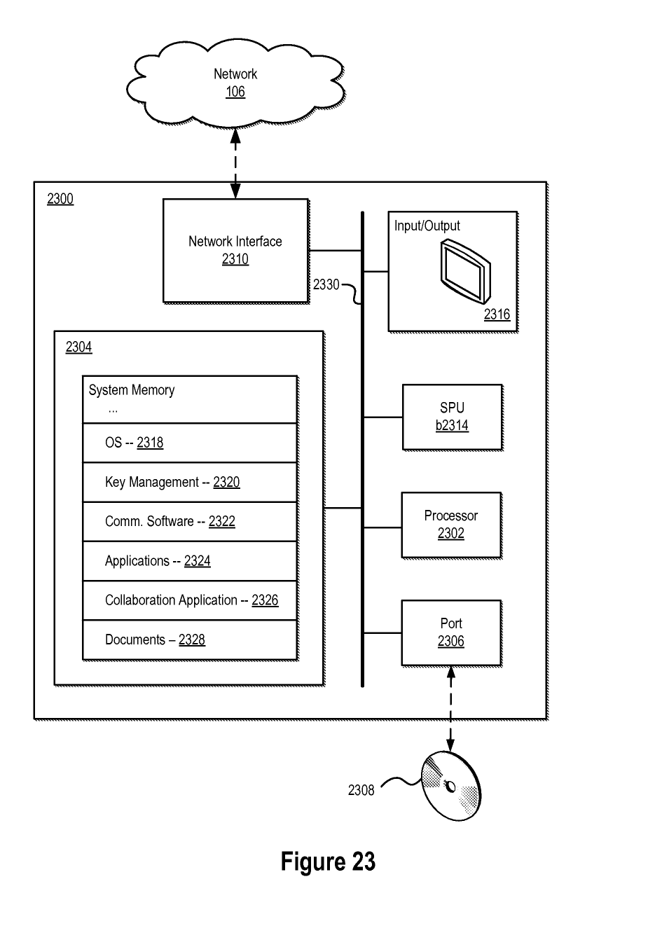

FIG. 23 illustrates an exemplary system 2300 that may be used to implement embodiments of the systems and methods disclosed herein. The exemplary system 2300 may comprise a device such as smartphone and/or a computer system that may perform the operations disclosed herein. As illustrated in FIG. 23, the system 2300 may include: a processing unit 2302; system memory 2304, which may include high speed random access memory (“RAM”), non-volatile memory (“ROM”), and/or one or more bulk non-volatile computer-readable storage mediums (e.g., a hard disk, flash memory, etc.) for storing programs and other data for use and execution by the processing unit 2302; a port 2306 for interfacing with removable memory 2308 that may include one or more diskettes, optical storage mediums (flash memory, thumb drives, USB dongles, compact discs, DVDs, etc.) and/or other computer-readable storage mediums; a network interface 2310 for communicating with other systems via one or more network connections 106 using one or more communication technologies; a user interface 2316 that may include a display and/or one or more input/output devices such as, for example, a touchscreen, a keyboard, a mouse, a track pad, and the like; and one or more busses 2330 for communicatively coupling the elements of the system 2300.

In some embodiments, the system 2300 may, alternatively or in addition, include a SPU 2314 that is protected from tampering by a user of system 2300 or other entities by utilizing secure physical and/or virtual security techniques. An SPU 2314 can help enhance the security of sensitive operations such as trusted credential and/or key management, secure document management, and other aspects of the systems and methods disclosed herein. In certain embodiments, the SPU 2314 may operate in a logically secure processing domain and be configured to protect and operate on secret information. In some embodiments, the SPU 2314 may include internal memory storing executable instructions or programs configured to enable to the SPU 2314 to perform secure operations. For example, in some embodiments an SPU 2314 such as described in commonly-assigned U.S. Pat. No. 7,430,585 (“the '585 patent”) and/or U.S. Pat. No. 5,892,900 (“the '900 patent”) could be used.

The operation of the system 2300 may be generally controlled by a processing unit 2302 and/or a SPU 2314 operating by executing software instructions and programs stored in the system memory 2304 (and/or other non-transitory computer-readable media, such as removable memory 2308). The system memory 2304 may store a variety of executable programs or modules for controlling the operation of the system 2300. For example, the system memory 2304 may include an operating system (“OS”) 2318 that may manage and coordinate, at least in part, system hardware resources and provide for common services for execution of various applications and a key management module 2320 configured to implement cryptographic key services and functionality. The system memory 2304 may further include, without limitation, communication software 2322 configured to enable in part communication within and by the system 2300, applications 2324 (e.g., third-party document editing applications), a collaboration application 2326, and/or locally stored documents 2328.

In certain embodiments, the systems and methods described herein could, for example, be used in connection with security and/or digital rights management (“DRM”) technologies such as those described in commonly assigned, co-pending U.S. patent application Ser. No. 11/583,693, filed Oct. 18, 2006, and published as Publ. No. 2007/0180519 A1 (“the '693 application”), U.S. Pat. No. 5,892,900, and U.S. Pat. No. 6,157,721 (“the '721 patent”), and/or service orchestration or DRM technologies such as those described in commonly assigned U.S. Pat. No. 8,234,387 (“the '387 patent”)(the contents of the '693 application and the '585 patent, '900 patent, '721 patent, and '387 patent hereby being incorporated by reference in their entireties). For example, DRM software and systems such as those described in the '693 application, the '387 patent, and/or the '900 patent could be used in some embodiments to facilitate the expression and enforcement of rules, rights, and policies of the type described herein. In will be appreciated, however, that any other suitable security and/or policy-enforcement software, systems, and/or mechanisms could be used instead or in addition.

The systems and methods disclosed herein are not inherently related to any particular computer, electronic control unit, or other apparatus and may be implemented by a suitable combination of hardware, software, and/or firmware. Software implementations may include one or more computer programs comprising executable code/instructions that, when executed by a processor, may cause the processor to perform a method defined at least in part by the executable instructions. The computer program can be written in any form of programming language, including compiled or interpreted languages, and can be deployed in any form, including as a standalone program or as a module, component, subroutine, or other unit suitable for use in a computing environment. Further, a computer program can be deployed to be executed on one computer or on multiple computers at one site or distributed across multiple sites and interconnected by a communication network. Software embodiments may be implemented as a computer program product that comprises a non-transitory storage medium configured to store computer programs and instructions, that when executed by a processor, are configured to cause the processor to perform a method according to the instructions. In certain embodiments, the non-transitory storage medium may take any form capable of storing processor-readable instructions on a non-transitory storage medium. A non-transitory storage medium may be embodied by a compact disk, digital-video disk, a magnetic tape, a magnetic disk, flash memory, integrated circuits, or any other non-transitory digital processing apparatus memory device.

Although the foregoing has been described in some detail for purposes of clarity, it will be apparent that certain changes and modifications may be made without departing from the principles thereof. It should be noted that there are many alternative ways of implementing both the systems and methods described herein. Accordingly, the present embodiments are to be considered as illustrative and not restrictive, and the invention is not to be limited to the details given herein, but may be modified within the scope and equivalents of the appended claims.

What is claimed is:

1. A method performed by a client system comprising a processor and a non-transitory computer-readable storage medium storing instructions that, when executed, cause the client system to perform the method, the method comprising:
displaying, on a user interface of the client system, information associated with a first task;
receiving an input from a user associated with the first task;
generating, first task activity information based on the input; and
displaying, in an activity stream of the user interface, the first task activity information.

2. The method of claim 1, wherein the first task activity information is displayed in the activity stream of the user interface in addition to the information associated with the first task.

3. The method of claim 1, wherein the input comprises a comment from the user regarding the first task.

4. The method of claim 1, wherein the input comprises an indication of a status associated with the first task.

5. The method of claim 1, wherein the input comprises an indication of a date associated with the first task.

6. The method of claim 1, wherein the input comprises uploading a document associated with the first task.

7. The method of claim 1, wherein the input comprises an indication of a user associated with the first task.

8. The method of claim 1, wherein the method further comprises displaying, on the user interface of the client system, information associated with a second task.

9. The method of claim 1, wherein the method further comprises displaying, in the activity stream of the user interface, second task activity information associated with the second task.

10. The method of claim 9, wherein the second task activity information is generated in response to an action performed by another user associated with the second task.
